(19) United States
(12) Patent Application Publication
(10) Pub. No.: US 2025/0029748 A1
(43) Pub. Date: Jan. 23, 2025

(54) Coated Overhead Conductor

(71) Applicant: Southwire Company, LLC, Carrollton, GA (US)

(72) Inventor: Marek Dariusz Burda, Peterborough (GB)

(73) Assignee: Southwire Company, LLC, Carrollton, GA (US)

(21) Appl. No.: 18/716,627

(22) PCT Filed: Dec. 7, 2022
(86) PCT No.: PCT/US2022/081091

§ 371 Date: Jun. 5, 2024

Related U.S. Application Data
(60) Provisional application No. 63/286,852, filed on Dec. 7, 2021.

(51) Int. Cl. H01B 9/00; H01B 1/02; H01B 3/12; H01B 13/16

(52) U.S. Cl. CPC H01B 9/008; H01B 1/023; H01B 3/12; H01B 13/165

(57) ABSTRACT

A coated overhead conductor comprising: a conductor comprising aluminum or an alloy thereof and a coating comprising (a) a ceramic or a ceramic and a filler; and (b) optionally a hydrophobe.

This application is being filed on 7 Dec. 2022, as a PCT International patent application, and claims priority to U.S. Provisional Patent Application No. 63/286,852, filed on 7 Dec. 2021, the disclosure of which is hereby incorporated by reference herein in its entirety.

### FIELD

Disclosed herein is an overhead conductor comprising a coating material and methods of manufacturing and using the coated overhead conductor.

### BACKGROUND

There exists a need for higher capacity electrical transmission and electrical distribution lines. Electrical transmission and distribution lines may be rated by their current-carrying capacity (viz., ampacity). Electrical line ampacity may be limited by a maximum operating temperature of the current-carrying conductor. Operating an electrical line at a temperature that exceeds the maximum operating temperature may impair the electrical and structural integrity of the line. The temperature of an electrical line may be influenced by amperage flow, solar radiation, ambient temperature, etc. Efforts to improve electrical line ampacity have been previously proposed by utilizing materials that possess characteristic coefficients of solar absorption and thermal emission. Solar absorptivity may be measured according to ASTM E903, while emissivity may be measured according to ASTM E408.

Some efforts have focused on using white overhead conductors that serve to reduce the coefficient of solar absorption. For instance, Simic proposed a coated overhead conductor (including, e.g., a white paint) having a reduced coefficient of solar absorption. Further, Sandrine proposed a coated overhead conductor (including a polymeric material (e.g., polyvinylidene) and a white pigment) having a reduced coefficient of solar absorption. Other efforts have focused on using black overhead conductors that serve to increase the coefficient of thermal emission. In this regard, Sallachner proposed a coated overhead conductor (including a polyurethane and graphite) having an increased coefficient of thermal emission. These previous efforts may be problematic because the coating may be readily lost due to delamination and/or external forces.

Davis and Mhetar focused on roughening the conductor surface by sand-blasting followed by applying a binder and a heat radiating agent. Siripurapu focused on a coating that includes a fluorocopolymer and a non-fluorinated film-forming polymer. Further, Dolan coated overhead conductors by electrochemically depositing a ceramic on the surface of the conductor. Deposition of a ceramic to the surface of a conductor (e.g., aluminum conductor) under ambient conditions may be problematic because of the differences in the coefficients of thermal expansion of the ceramic and the conductor material, which may lead to cracking and irregularities on the surface of the coating.

Investigatory developments reported herein provide a coated overhead conductor that overcome problematic features of the previously reported coated overhead conductors.

### SUMMARY

A coated overhead conductor comprising: a conductor comprising aluminum or an alloy thereof and a coating comprising (a) a ceramic, a filler, an aluminum, or a combination thereof; and (b) optionally a hydrophobe.

### BRIEF DESCRIPTION OF THE DRAWINGS

The foregoing and other objects, features and advantages of the embodiment and methods disclosed herein will be apparent from the following description of embodiments thereof, as illustrated in the accompanying drawings. The drawings are not necessarily to scale, emphasis instead being placed upon illustrating the principles of the embodiments and methods disclosed herein.

FIG. 1 represents a schematic of powder materials contemplated herein.

FIG. 2 represents SEM images of black titania coated aluminum conductor as made (FIG. 2A (#1000) and FIG. 2C (#1001)) and mandrel-elongated (FIG. 2B (#1000) and FIG. 2D (#1001)) using 12.7 mm diameter mandrel.

### DETAILED DESCRIPTION

The use of the terms “a” and “an” and “the” and similar references in the context of describing the coated overhead conductor described herein (especially in the context of the following claims) are to be construed to cover both the singular and the plural, unless otherwise indicated herein or clearly contradicted by context.

The term “about” as used herein embodies standard error associated with a certain observable. As used herein, the term “about” means a slight variation of the value specified, for example, within 10% of the value specified. A stated amount for a component, material, or observable that is not preceded by the term “about” does not mean that there is no variance for the stated term, as one of ordinary skill would understand that there may be the possibility of a degree of variability generally associated with experimental error.

References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, unless otherwise indicated or made clear from the context, the term “or” should generally be understood to mean “and/or” and, similarly, the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the embodiments.

In the following description, it is understood that terms such as “first,” “second,” “third,” “primary,” “secondary,” “above,” “below,” and the like, are words of convenience and are not to be construed as implying a chronological order or otherwise limiting any corresponding element unless expressly stated otherwise.

### Coated Overhead Conductor

A first embodiment relates to a coated overhead conductor comprising: a conductor comprising aluminum or an alloy thereof and a coating comprising (a) a ceramic, a filler, an aluminum, or a combination thereof; and (b) optionally a hydrophobe.

The conductor contemplated herein relates generally to a conductor used for high-temperature applications. The conductor comprises a plurality of peripheral and interior wires arranged in a concentric array that extend along a longitudinal axis of the conductor. For instance, an aluminum conductor contemplated herein includes, but is not limited to, an aluminum conductor steel supported (ACSS); an aluminum conductor composite single (ACCS); a thermal aluminum alloy conductor composite reinforced (ZTACCR), where the aluminum alloy comprises a high-temperature aluminum-zirconium alloy; a thermal resistant aluminum conductor steel reinforced (ZTACSR), and the like.

One may appreciate that the conductor (e.g., ACSS, etc.), may be used for overhead electrical distribution and in electrical transmission lines. The conductor (e.g., ACSS) may be designed to operate continuously at elevated temperatures of up to 250° C. without loss of strength. Generally, an ACSS is a composite concentric-lay stranded conductor. Steel strands form the central core of the conductor with two or more layers of aluminum 1350-O wire stranded around it. The steel core carries most or all the mechanical load of the conductor due to the “O” temper (fully annealed or soft) aluminum. Steel core wires may be protected from corrosion by a zinc-5% aluminum-mischmetal alloy coating. The conductor (e.g., ACSS) may be protected from corrosion using a coating described herein. ACSS cables are known generally by code words, e.g., Drake/ACSS, Tern/ACSS, and the like. For instance, a Drake/ACSS refers generally to a 795 kcmil sized conductor having a 26/7 stranding and an ampacity of about 1662 Amps at 200° C. Sec, e.g., ACSS Product Information and OHCM.

Accordingly, one aspect relates to a coated overhead conductor comprising: a conductor comprising aluminum or an alloy thereof and a coating comprising (a) a ceramic, a filler, an aluminum, or a combination thereof; and (b) optionally a hydrophobe; wherein the conductor comprises an ACSS, an ACCS, a ZTACCR, or a ZTACSR.

A suitable ceramic comprises a ceramic capable of melting without decomposition at a temperature used to generate a thermal spray. Examples of ceramics contemplated herein include, but are not limited to, alumina, mullite, spinel, black titania, copper (II) oxide (aka CuO or cupric oxide), or a combination thereof. Ceramics contemplated herein may have a micron particle size, a submicron particle size, a nanometer particle size, or a combination thereof.

Alumina (aluminum oxide, e.g., Al₂O₃) may be obtained commercially. For instance, commercial alumina may be obtained from UKGE Ltd. The obtained alumina has a nominal particle size of about 31 μm, a melting point of about 2072° C., and a density of about 3.95 g/cm³. For instance, alumina contemplated herein may have a particle size of about 10 μm to about 100 μm.

Mullite (aluminum silicate, e.g., 3Al₂O₃·2SiO₂) may be obtained commercially. For instance, commercial mullite may be obtained from Saint-Gobain. The obtained mullite has a nominal particle size range of 10 μm to about 45 μm, a melting point of about 1840° C., and a density of about 3.1 g/cm³.

Spinel represent a class of minerals that may be represented generally as AD₂X₄, where A may be A=Fe, Mn, Mg, Mn, Si, Ge, Co, Cu, Sb, Zn, Ti, Ni, or a combination thereof; D may be Fe, Cr, V, Mn, Al, Co, In, Ir, Rh, Pt, Ni, or a combination thereof; and X may be O, S, Se, or a combination thereof. See, e.g., MinDat. The coating may comprise any suitable spinel, including, for example, Spinel (MgAl₂O₄), Gahnite (ZnAl₂O₄), Hercynite: (FeAl₂O₄), Galaxite (MnAl₂O₄), Pleonaste ((Mg,Fe)Al₂O₄), Cuprospinel (CuFe₂O₄), Franklinite ((Fe,Mn,Zn)(Fe,Mn)₂O₄), Jacobsite (MnFe₂O₄), Magnesioferrite (MgFe₂O₄), Magnetite (FeFe₂O₄), Trevorite (NiFe₂O₄), Ulvöspincel (TiFe₂O₄), Zinc ferrite ((Zn,Fe)Fe₂O₄), Chromite (FeCr₂O₄), Magnesiochromite (MgCr₂O₄), Zincochromite (ZnCr₂O₄), Manganesecobaltite (Mn_{1.5}C_{01.5}O₄), Coulsonite (FeV₂O₄), Magnesiocoulsonite (MgV₂O₄), and the like. Spinel may be manufactured or may be obtained commercially. For instance, magnesium aluminate (viz., MgAl₂O₄) may be obtained commercially from Saint-Gobain having a nominal particle size range of about 15 μm to about 45 μm, a melting point of about 2135° C., and a density of about 3.58 g/cm³.

One will appreciate that black titania (TiO₂₋ₓ) differs compositionally from titania (TiO₂) by the presence of a certain amount of Ti³⁺ cations, as opposed to only Ti⁴⁺ cations found in titania. Glezakou. Black titania may be obtained commercially or manufactured by known methods (see, e.g., Sinhamahapatra and Janczarek). For instance, commercial black titania may be obtained from Saint-Gobain (e.g., Titania #1000 or Titania #1001). Titania #1000 has a nominal size of about 5 μm to about 25 μm and comprises TiO₂₋ₓ (97.23%), Al₂O₃ (2.35%), SiO₂ (0.06%), Fe₂O₃ (0.03%), and ZrO (0.23%), and other oxides (0.10%). Titania #1001 has a nominal size of about 10 μm to about 63 μm, a density of about 4.23 g/cm³, and comprises TiO₂₋ₓ (99.62%), Al₂O₃ (0.18%), SiO₂ (0.03%), Fe₂O₃ (0.04%), and other oxides (0.13%) and other trace oxides, including Na₂O (0.01%), CaO (0.02%), Cr₂O₃ (0.02%), Y₂O₃ (<0.01%), HfO₂ (<0.01%), V₂O₅ (<0.01%), MnO₂ (0.01%), K₂O (0.01%), CeO₂ (<0.01%), Co₃O₄ (<0.01%), SnO (<0.01%), ZnO (<0.01%), CuO (<0.01%), WO₃ (<0.01%), MoO₃ (<0.01%), B₂O₃ (<0.01%), Ta₂O₅ (<0.01%)).

Copper (II) oxide (CuO or cupric oxide) contemplated herein includes, for example, copper (II) oxide from Inoxia Ltd Purity: 98.5%; Particle size: about 300 mesh (<54μ) Color: black; Impurities: Fe (0.01%), Pb (0.05%), Zn (0.05%), Na (0.3%), SiO2 (0.3%), Moisture (0.2%), all maximums.

A suitable filler may be a hydrophobic material, a pigment, or a combination thereof. For instance, a filler having a hydrophobic property includes, for example, one or more of a rare earth metal compound (“REC”), a graphite, a graphene, a carbon nanotube (“CNT”), a hexagonal boron nitride (“hBN”), or a combination thereof. Alternatively, a filler having a pigmentation property includes, for example, lamp black (“LB”), carbon black (“CB”), cupric oxide (CuO), an iron (II) oxide, an iron (III) oxide, an iron (II,III) oxide, white titania (TiO₂), or a combination thereof.

Examples of RECs contemplated herein include, but are not limited to, a rare earth metal oxide (REO), a rare earth metal phosphate (“REP”), and the like. REOs include, e.g., CeO₂, Pr₆O₁₁, Nd₂O₃, Sm₂O₃, Eu₂O₃, Gd₂O₃, Tb₄O₇, Dy₂O₃, Ho₂O₃, Er₂O₃, Tm₂O₃, Yb₂O₃, Lu₂O₃, La₂O₃. REPs include, e.g., LuPO₄, YbPO₄, TmPO₄, ErPO₄, HoPO₄, DyPO₄, TbPO₄, GdPO₄, EuPO₄, SmPO₄, NdPO₄, PrPO₄, CePO₄, and LaPO₄. Hydrophobicity of REOs and REPs may improve water repellency of the functional coating (see, e.g., Azimi and Sankar).

A coating comprising an aluminum contemplated herein includes aluminum and an aluminum alloy (collectively the “coating-aluminum”), e.g., Al 99.5%, Al (99.0%), Al-5% Mg, Al-12% Si), and the like. For instance, an aluminum powder contemplated herein may be obtained commercially from Inoxia Ltd. Particle size <250 mesh; Purity 99.5%. One will appreciate that the coating-aluminum elemental composition may be the same or different from the conductor-aluminum (or conductor aluminum alloy) elemental composition.

In one aspect, the coating comprises (a) a ceramic, a filler, an aluminum, or a combination thereof; and (b) optionally a hydrophobe. For illustrative purposes, the coating may comprise: (i) a ceramic; (ii) a ceramic and a hydrophobe; (iii) a first ceramic and a second ceramic; (iv) a first ceramic, a second ceramic, and a hydrophobe; (iv) a ceramic and a filler; (v) a ceramic, a filler, and a hydrophobe; (vi) an aluminum and a filler; and the like. The information that follows further illustrates various features of the coated overhead conductor disclosed herein.

In one aspect, the coating may be deposited on the surface of the conductor by a thermal spray. In another aspect, the coating may be deposited on the surface of the conductor by a thermal spray and an alternative deposition method (e.g., a non-thermal method, including, for example, cold spraying, spraying, immersing, painting, and the like).

One may appreciate that a thermal spray method generally may utilize any material capable of melting (totally or partially) without decomposition at a temperature used to generate the thermal spray. An alternative thermal spray method (e.g., kinetic (e.g., cold spray)) deposition method may be used for materials that may decompose in a thermal spray. Generally, a thermal spray method (except for certain methods, e.g., cold spray (see, e.g., Winnicki)) results in the acceleration of a powder particle material into a non-ambient thermal zone (e.g., flame, plasma, etc.), where the powder particle material liquifies (totally or partially) providing molten particles (or molten droplets) comprising liquified material, solid material, or a combination thereof. The molten particles impact the solid substrate (e.g., the conductor) and flatten upon impact forming splattered droplets (or splats) which form the coating. Sec, e.g., Fauchais at 70. As the splattered droplets accumulate on the surface of the substrate (e.g., the conductor), a layering effect may occur, creating a continuum of overlaid splats. The thickness of the coating may depend on numerous factors, including, for example, the feedstock material particle size, the exposure time of the substrate (e.g., the conductor) with the molten particles, the flame/gas velocity, and the like. One will appreciate that the coating may comprise a splat, an unmelted particle, a partially melted particle/resolidified particle, an oxide region, and the like. One also will appreciate that the coating may comprise a degree of porosity where a void space may exist within the continuum of overlaid splats. See, e.g., Tejero-Martin at 601. A coated overhead conductor, when bent, may include one or more microcracks. The presence of one or more microcracks may be beneficial because of mismatch in coefficient of thermal expansion between aluminum conductor and the coating (e.g., ceramic).

Thermal spraying may be achieved by numerous methods, including, but not limited to plasma (e.g., atmospheric or reduced pressure), wire arc, flame (e.g., powder, wire, or rod), and kinetic (e.g., cold spraying). Sec, e.g., Tejero-Martin at 601, Vuoristo at 237, and Winnicki. Contemplated spraying techniques include, but are not limited to, powder/wire flame spray, arc spraying, plasma spraying, high velocity oxy fuel (HVOF), high velocity flame spray (HVFS), high velocity air fuel (HVAF), detonation flame (D-gun), cold spray, and the like.

In another aspect of the first embodiment, the coated overhead aluminum conductor comprises an interfacial weld (or bond) between the coating layer and the conductor. Scanning electron microscopy shows that aluminum infiltrates the coating layer. Indeed, energy dispersive X-ray analysis (EDX) of coated overhead conductor samples confirmed the existence of aluminum intermixed with the coating layer showing clear interfacial weld between the coating layer and the conductor. The EDX results (not presented herein show that the coating layer includes about 22% w/w of aluminum in the coating layer based on the total weight of the coating layer. In yet another aspect of the first embodiment, the coating layer comprises about 10% w/w to about 30% w/w of aluminum and all values in between, such as, for example, about 12% w/w, about 14% w/w, 16% w/w, 18% w/w, 20% w/w, 22% w/w, 24% w/w, 26% w/w, and 28% w/w.

As related to the first embodiment, the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm.

Thus, an aspect of the first embodiment relates to a coated overhead conductor comprising: a conductor comprising aluminum or an alloy thereof and a coating comprising (a) a ceramic, a filler, an aluminum, or a combination thereof; and (b) optionally a hydrophobe; wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm about 50 μm.

As stated above, one will appreciate that the coating may comprise a degree of porosity where a void space may exist within the continuum of overlaid splats. In certain instances, it may be desirable to apply a hydrophobe to the coating that functions to impart a certain degree of water repellency to the overhead conductor. For a coated overhead conductor to be used in an arid climate, it may not be desirable to apply a hydrophobe to a coated conductor. In contrast, it may be desirable to apply a hydrophobe to a coated conductor for rainy or icy climates, or for a coastal climate which may result in exposure from ambient moisture having a certain salinity.

Accordingly, another aspect of the first embodiment relates to a hydrophobic-coated overhead conductor comprising: a conductor comprising aluminum or an alloy thereof and a coating comprising (a) a ceramic, a filler, an aluminum, or a combination thereof; and (b) a hydrophobe.

The term “hydrophobe” generally refers to a hydrophobic material that may increase the water-repellency of the coated overhead conductor. Water repellency may be determined, for example, by contacting the coated substrate with a water droplet (having a volume of about 10 μL to about 60 μL), imaging the water droplet on the coated substrate, and measuring the contact angle using an imaging routine (e.g., ImageJ). Generally, the contact angle may be defined as the angle between the surface and the tangent-line of the water droplet where the water droplet contacts the surface. See Tejero-Martin at 610. An alternative method for determining water repellency may be determining the slide angle of the coated overhead conductor. Law. In certain aspects, a water droplet on the hydrophobic-coated overhead conductor has contact angle of at least 90° and/or a slide angle of at most about 10°. In certain aspects, the observed contact angle may be about 140° for a 10 μL water droplet and a sliding angle of about 10° for a 20 μL water droplet.

Thus, another aspect of the first embodiment relates to a hydrophobic-coated overhead conductor comprising: a conductor comprising aluminum or an alloy thereof and a coating comprising (a) a ceramic, a filler, an aluminum, or a combination thereof; and (b) a hydrophobe; wherein a water droplet on the coating has a water contact angle of at least 90° and all values up to about 180°, including, for example about 85°, about 90°, about 95°, about 100°, about 105°, about 110°, about 115°, about 120°, about 125°, about 130°, about 140°, about 150°, about 160°, and about 170°.

The hydrophobic material may be applied by air spraying, brushing, dipping, dipping in a sol-gel solution, and the like. See, e.g., Arkles, Heiman-Burstein, and Polizos.

One may appreciate that application of a hydrophobe to the coated conductor may fill a void space that may exist within the splats and result in a topcoat on the surface of the coating. Thickness of the hydrophobe on the surface of the coating may depend on the hydrophobe, e.g., from about 1 nm to about 20 nm and all values in between for a fluoroalkyl-silane (e.g., Dynasylan 8263), a hydrophobe thickness of from about 60 nm to about 100 nm for a Nasiol-based hydrophobe, or a hydrophobe thickness of from about 0.1 to about 10 μm for a Dynasylan 1146 based hydrophobe.

Yet another aspect of the first embodiment relates to a hydrophobic-coated overhead conductor comprising: a conductor comprising aluminum or an alloy thereof and a coating comprising (a) a ceramic, a filler, an aluminum, or a combination thereof; and (b) a hydrophobe; wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

Yet another aspect of the first embodiment relates to a hydrophobic-coated overhead conductor comprising: a conductor comprising aluminum or an alloy thereof and a coating comprising (a) a ceramic, a filler, an aluminum, or a combination thereof; and (b) a hydrophobe; wherein a water droplet on the coating has a water contact angle of at least 90° and all values up to about 180°; and wherein the coating has a thickness of about 5 μm to about 100 μm.

Certain aspects disclosed herein may relate to either a coated overhead conductor or a hydrophobic-coated overhead conductor, which are collectively referred to as a “(hydrophobic-) coated overhead conductor.

For instance, in one aspect, the (hydrophobic-) coated overhead conductor disclosed herein has a reduced temperature, compared to an uncoated overhead conductor, when bearing a load of about 200 Å to about 300 A. In one aspect, the (hydrophobic-) coated overhead conductor disclosed herein has a temperature (i) of from about 10% to about 25% lower than an uncoated conductor each illuminated with light and each bearing a load of 200 A; (ii) of from about 25% to about 55% lower than an uncoated conductor each illuminated with no light and each bearing a load of 200 A; (iii) of from about 35% to about 45% lower than an uncoated conductor each illuminated with light and each bearing a load of 300 A; and/or (vi) of from about 35% to about 45% lower than an uncoated conductor each illuminated with no light and each bearing a load of 300 A.

In yet another aspect, the (hydrophobic-) coated overhead conductor further comprises one or more indicia comprising an inorganic pigment. Examples of inorganic pigments include, but are not limited to, anatine, aureolin, azurite, brookite, burnt sienna, burnt umber, cadmium green, cadmium red, cadmium yellow, caput mortuum, cerulean blue, clay earth pigments, cobalt blue, cobalt yellow, copper pigments, Egyptian blue, Han blue, Han purple, iron oxide pigments, malachite, marine pigments (ultramarine, ultramarine green shade), orange cobalt, oxide red, Paris green, phthalocyanine blue BN, phthalocyanine green G, Prussian blue, raw sienna, raw umber, red ochre, rutile, sanguine, titanium dioxide, Venetian red, verdigris, viridian, yellow ochre, zinc pigments (zinc white, zinc ferrite), and combinations thereof.

In yet another aspect, the (hydrophobic-) coated overhead conductor further comprises one or more indicia comprising a temperature indicator. The temperature indicator may comprise an irreversible thermochromic pigment, such as ultramarine pink (CAS No. 12769-96-9), ultramarine violet (CAS No. 12769-96-9), manganese violet (CAS No. 10101-66-3), as well as NiCl₂·6H₂O, NiCO₃, ZnO, [Co(NH₃)₆]PO₄, Cu(NO₃)₂·3H₂O (see Day). The indicia may comprise numerical markings (e.g., “250° C.” or “Drake”) that permit visual inspection showing an associated temperature change. For instance, an ACSS cable (e.g., Drake/ACSS/795) is designed to operate at elevated temperatures up to 250° C. Use of an irreversible thermochromic pigment with a color transition of about 250° C. (e.g., ZnO) permits one to readily determine if the ACSS cable was operating at an elevated temperature. The markings may be applied to the coated overhead aluminum conductor by way of brushing, spraying (e.g., template spraying), and the like.

The information that follows further illustrates certain aspects of the first embodiment.

### First Aspect: Ceramic Coating and Optionally a Hydrophobe

A first aspect of the first embodiment relates to a coated overhead conductor comprising: a conductor comprising aluminum or an alloy thereof and a coating comprising (a) a ceramic; and (b) optionally a hydrophobe.

One aspect relates to a coated overhead conductor comprising: a conductor comprising aluminum or an alloy thereof and a coating comprising (a) a ceramic; and (b) optionally a hydrophobe; wherein the conductor comprises an ACSS, an ACCS, a ZTACCR, or a ZTACSR.

Another aspect relates to a coated overhead conductor comprising: a conductor comprising aluminum or an alloy thereof and a coating comprising (a) a ceramic; and (b) optionally a hydrophobe; wherein the ceramic comprises alumina, mullite, spinel, black titania, cupric oxide, or a combination thereof.

One aspect relates to a coated overhead conductor comprising: a conductor comprising aluminum or an alloy thereof and a coating comprising (a) a ceramic; and (b) optionally a hydrophobe; wherein the conductor comprises an ACSS, an ACCS, a ZTACCR, or a ZTACSR; and wherein the ceramic comprises alumina, mullite, spinel, black titania, cupric oxide, or a combination thereof.

Yet another aspect relates to a coated overhead conductor comprising: a conductor comprising aluminum or an alloy thereof and a coating comprising (a) a ceramic and (b) optionally a hydrophobe; wherein the ceramic comprises alumina, mullite, spinel, black titania, cupric oxide, or a combination thereof; and wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

A further aspect relates to a coated overhead conductor comprising: a conductor comprising aluminum or an alloy thereof and a coating comprising (a) black titania and (b) optionally a hydrophobe.

A further aspect relates to a coated overhead conductor comprising: a conductor comprising aluminum or an alloy thereof and a coating comprising (a) black titania and (b) optionally a hydrophobe; wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 10 μm to about 60 μm or the coating may have a thickness of about 50 μm.

### Second Aspect: Ceramic Coating and Hydrophobe

A second aspect of the first embodiment relates to a hydrophobic-coated overhead conductor comprising: a conductor comprising aluminum or an alloy thereof and a coating comprising (a) a ceramic; and (b) a hydrophobe.

One aspect relates to a coated overhead conductor comprising: a conductor comprising aluminum or an alloy thereof and a coating comprising (a) a ceramic; and (b) a hydrophobe; wherein the conductor comprises an ACSS, an ACCS, a ZTACCR, or a ZTACSR.

A further aspect relates to a hydrophobic-coated overhead conductor comprising: a conductor comprising aluminum or an alloy thereof and a coating comprising (a) a ceramic and (b) a hydrophobe; wherein the first ceramic comprises alumina, mullite, spinel, black titania, or cupric oxide.

A further aspect relates to a hydrophobic-coated overhead conductor comprising: a conductor comprising aluminum or an alloy thereof and a coating comprising (a) a ceramic and (b) a hydrophobe; wherein the conductor comprises an ACSS, an ACCS, a ZTACCR, or a ZTACSR; and wherein the first ceramic comprises alumina, mullite, spinel, black titania, or cupric oxide.

Yet another aspect relates to a hydrophobic-coated overhead conductor comprising: a conductor comprising aluminum or an alloy thereof and a coating comprising (a) a ceramic and (b) a hydrophobe; wherein the ceramic comprises alumina, mullite, spinel, black titania, or cupric oxide; and wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

A further aspect relates to a hydrophobic-coated overhead conductor comprising: a conductor comprising aluminum or an alloy thereof and a coating comprising (a) black titania and (b) a hydrophobe.

A further aspect relates to a hydrophobic-coated overhead conductor comprising: a conductor comprising aluminum or an alloy thereof and a coating comprising (a) black titania and (b) a hydrophobe; wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

Another aspect of the first embodiment relates to a hydrophobic-coated overhead conductor comprising: a conductor comprising aluminum or an alloy thereof and a coating comprising (a) a ceramic and (b) a hydrophobe; wherein a water droplet on the coating has a water contact angle of at least 90° and all values up to about 180°, as stated above.

A further aspect relates to a hydrophobic-coated overhead conductor comprising: a conductor comprising aluminum or an alloy thereof and a coating comprising (a) a ceramic and (b) a hydrophobe; wherein the ceramic comprises alumina, mullite, spinel, black titania, or cupric oxide; wherein a water droplet on the coating has a water contact angle of at least 90° and all values up to about 180°, including, for example about 85°, about 90°, about 95°, about 100°, about 105°, about 110°, about 115°, about 120°, about 125°, about 130°, about 140°, about 150°, about 160°, and about 170°.

Yet another aspect relates to a hydrophobic-coated overhead conductor comprising: a conductor comprising aluminum or an alloy thereof and a coating comprising (a) a ceramic and (b) a hydrophobe; wherein the ceramic comprises alumina, mullite, spinel, black titania, or cupric oxide; wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm.; and wherein a water droplet on the coating has a water contact angle of at least 90° and all values up to about 180°, including, for example about 85°, about 90°, about 95°, about 100°, about 105°, about 110°, about 115°, about 120°, about 125°, about 130°, about 140°, about 150°, about 160°, and about 170°.

A further aspect relates to a hydrophobic-coated overhead conductor comprising: a conductor comprising aluminum or an alloy thereof and a coating comprising (a) black titania and (b) a hydrophobe; wherein a water droplet on the coating has a water contact angle of at least 90° and all values up to about 180°, including, for example about 85°, about 90°, about 95°, about 100°, about 105°, about 110°, about 115°, about 120°, about 125°, about 130°, about 140°, about 150°, about 160°, and about 170°.

A further aspect relates to a hydrophobic-coated overhead conductor comprising: a conductor comprising aluminum or an alloy thereof and a coating comprising (a) black titania and (b) a hydrophobe; wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm.; and wherein a water droplet on the coating has a water contact angle of at least 90° and all values up to about 180°, including, for example about 85°, about 90°, about 95°, about 100°, about 105°, about 110°, about 115°, about 120°, about 125°, about 130°, about 140°, about 150°, about 160°, and about 170°.

### Third Aspect: Two or More Ceramics and Optionally Hydrophobe

A third aspect of the first embodiment relates to a coated overhead conductor comprising: a conductor comprising aluminum or an alloy thereof and a coating comprising (a) a ceramic, and (b) optionally a hydrophobe; wherein the ceramic comprises alumina, mullite, spinel, black titania, magnetite, cupric oxide, or a combination thereof.

Suitable ceramics comprise two or more ceramics capable of melting without decomposition at a temperature used to generate the thermal spray. Examples of ceramics contemplated herein include, but are not limited to, alumina, mullite, spinel, black titania, magnetite, cupric oxide, or a combination thereof. The coating may comprise a mixture of ceramics. Alternatively, the coating may comprise an underlayer comprising a first ceramic and an overlayer comprising a second ceramic. In the instance where the coating comprises an underlayer and an overlayer, one may appreciate that the underlayer may be disposed between the conductor and the overlayer. For instance, the underlayer may comprise a high emissivity ceramic (e.g., black titania), while the overlayer may comprise a ceramic having high solar reflectivity.

Another aspect relates to a coated overhead conductor comprising: a conductor comprising aluminum or an alloy thereof and a coating comprising (a) a ceramic and (b) optionally a hydrophobe; wherein the ceramic comprises alumina, mullite, spinel, black titania, cupric oxide, or a combination thereof; and wherein the conductor comprises an ACSS, an ACCS, a ZTACCR, or a ZTACSR.

In one aspect, the coating may comprise a first ceramic (99% w/w) and a second ceramic (1% w/w) giving a weight ratio of about 99:1. Alternatively, the coating may comprise a first ceramic (1% w/w) and a second ceramic (99% w/w) giving a weight ratio of about 1:99. In one aspect, the weight ratio of the first-to-second ceramics ranges from about 99:1 to about 1:99 and all values in between, including weight ratios of first ceramic to second ceramic of about 98:2, about 95:5, about 90:10, about 85:15, about 80:20, about 75:25, about 70:30, about 65:35, about 60:40, about 55:45, about 50:50, about 45:55, about 40:60, about 35:65, about 30:70, about 25:75, about 20:80, about 15:85, about 10:90, about 5:95, and about 2:98.

Yet another aspect relates to a coated overhead conductor comprising: a conductor comprising aluminum or an alloy thereof and a coating comprising (a) black titania; (b) spinel; and (c) optionally a hydrophobe.

A further aspect relates to a coated overhead conductor comprising: a conductor comprising aluminum or an alloy thereof and a coating comprising (a) black titania; (b) spinel; and (c) optionally a hydrophobe; wherein a weight ratio of black titania to spinel ranges from about 99:1 to about 1:99, and all values in between, including weight ratios of black titania to spinel of about 98:2, about 95:5, about 5:1, about 1:1, about 1:2, about 1:5, about 1:10, about 5:95, and about 2:98. In one aspect, the weight ratio of black titania to spinel may be about 99:1, about 95:5, about 5:1, and all values in between.

A further aspect relates to a coated overhead conductor comprising: a conductor comprising aluminum or an alloy thereof and a coating comprising (a) black titania; (b) spinel; and (c) optionally a hydrophobe; wherein a weight ratio of black titania to spinel ranges from about 99:1 to about 1:99, and all values in between, as stated above; and wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 40 μm to about 60 μm or the coating may have a thickness of about 50 μm.

Yet another aspect relates to a coated overhead conductor comprising: a conductor comprising aluminum or an alloy thereof and a coating comprising (a) black titania, (b) cupric oxide, and (c) optionally a hydrophobe.

A further aspect relates to a coated overhead conductor comprising: a conductor comprising aluminum or an alloy thereof and a coating comprising (a) black titania, (b) cupric oxide, and (c) optionally a hydrophobe; wherein a weight ratio of black titania to cupric oxide ranges from about 99:1 to about 50:50, including weight ratios of black titania to CuO of about 95:5, about 90:10, about 85:15, about 80:20, about 75:25, about 70:30, about 65:35, about 60:40, and about 55:45. In certain instances, it may be of interest to utilize a weight ratio of black titania to cupric oxide of about 95:5, about 90:10, about 85:15, about 80:20, about 75:25, and about 70:30. Further, it may be of interest to utilize a non-reducing (or oxidizing) flame method so that CuO may not be reduced during the deposition process.

A further aspect relates to a coated overhead conductor comprising: a conductor comprising aluminum or an alloy thereof and a coating comprising (a) black titania, (b) cupric oxide, and (c) optionally a hydrophobe; wherein a weight ratio of black titania to cupric oxide ranges from about 99:1 to about 50:50, including weight ratios of black titania to CuO of about 95:5, about 90:10, about 85:15, about 80:20, about 75:25, and about 70:30; wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

Yet another aspect relates to a coated overhead conductor comprising: a conductor comprising aluminum or an alloy thereof and a coating comprising (a) black titania, (b) magnetite, and (c) optionally a hydrophobe.

A further aspect relates to a coated overhead conductor comprising: a conductor comprising aluminum or an alloy thereof and a coating comprising (a) black titania, (b) magnetite, and (c) optionally a hydrophobe; wherein a weight ratio of black titania to magnetite ranges from about 98:2 to about 50:50, and all values in between, including weight ratios of black titania to magnetite of about 90:10, about 85:15, about 80:20, about 75:25, about 70:30, about 65:35, about 60:40, and about 55:45. In one aspect, the weight ratio of black titania to magnetite may be about 35:1, about 20:1, about 10:1, about 5:1, and all values in between.

A further aspect relates to a coated overhead conductor comprising: a conductor comprising aluminum or an alloy thereof and a coating comprising (a) black titania, (b) magnetite, and (c) optionally a hydrophobe; wherein a weight ratio of black titania to magnetite ranges from about 98:2, and all values in between, including weight ratios of black titania to magnetite of about 95:5, about 90:10, about 85:15, about 80:20, about 75:25, about 70:30, about 65:35, about 60:40, about 55:45, and about 50:50, etc.; and wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

### Fourth Aspect: Two or More Ceramics and Hydrophobe

A fourth aspect of the first embodiment relates to a hydrophobic-coated overhead conductor comprising: a conductor comprising aluminum or an alloy thereof and a coating comprising (a) a ceramic; and (b) a hydrophobe.

Suitable ceramics comprise two or more ceramics capable of melting without decomposition at a temperature used to generate the thermal spray. Examples of ceramics contemplated herein include, but are not limited to, alumina, mullite, spinel, black titania, magnetite, cupric oxide, or a combination thereof.

Another aspect relates to a hydrophobic-coated overhead conductor comprising: a conductor comprising aluminum or an alloy thereof and a coating comprising (a) a ceramic and (b) a hydrophobe; wherein the ceramic comprises alumina, mullite, spinel, black titania, cupric oxide, or a combination thereof; and wherein the conductor comprises an ACSS, an ACCS, a ZTACCR, or a ZTACSR.

In one aspect, the coating may comprise a first ceramic (99% w/w) and a second ceramic (1% w/w) giving a weight ratio of about 99:1. Alternatively, the coating may comprise a first ceramic (1% w/w) and a second ceramic (99% w/w) giving a weight ratio of about 1:99. In one aspect, the weight ratio of the first ceramic to the second ceramic ranges from about 99:1 to about 1:99 and all values in between, including weight ratios of first ceramic to second ceramic of about 98:2, about 95:5, about 90:10, about 85:15, about 80:20, about 75:25, about 70:30, about 65:35, about 60:40, about 55:45, about 50:50, about 45:55, about 40:60, about 35:65, about 30:70, about 25:75, about 20:80, about 15:85, about 10:90, about 5:95, and about 2:98.

In the instance where the ceramic comprises a first ceramic, a second ceramic, and a third ceramic, the amounts for each of the ceramics sum to 100 parts by weight based on the total ceramic weight. One will appreciate the amount of each ceramic independently may vary from about 1% w/w to about 99% w/w based on the total weight of the ceramic. For instance, a ceramic comprising black titania, spinel, and alumina may comprise about 80% by weight of black titania, about 10% by weight of spinel, about 10% by weight of alumina.

In the instance where the ceramic comprises n-ceramics, one also will appreciate that a weight amount of ceramic may be f₁C₁+f₂C₂+ . . . fₙCₙ, where f₁, f₂, . . . fₙ represents the weight fraction of for each ceramic (C₁, C₂, . . . Cₙ).

A weight ratio of the ceramic to filler may vary depending on the desired property (e.g., hydrophobicity or pigmentation) of the coating. Generally, the coating has a weight ratio of ceramic to filler that ranges from about 99:1 to about 50:50 and all values in between, including weight ratios of ceramic to filler of about 90:10, about 85:15, about 80:20, about 75:25, about 70:30, about 65:35, about 60:40, about 55:45, and 50:50, etc.

Yet another aspect relates to a hydrophobic-coated overhead conductor comprising: a conductor comprising aluminum or an alloy thereof and a coating comprising (a) black titania; (b) spinel; and (c) a hydrophobe.

A further aspect relates to a hydrophobic-coated overhead conductor comprising: a conductor comprising aluminum or an alloy thereof and a coating comprising (a) black titania; (b) spinel; and (c) a hydrophobe; wherein a weight ratio of black titania to spinel ranges from about 99:1 to about 1:99, and all values in between, including weight ratios of black titania to spinel of about 98:2, about 95:5, about 5:1, about 1:1, about 1:2, about 1:5, about 1:10, about 5:95, and about 2:98. In one aspect, the weight ratio of black titania to spinel may be about 99:1, about 95:5, about 5:1, and all values in between.

A further aspect relates to a hydrophobic-coated overhead conductor comprising: a conductor comprising aluminum or an alloy thereof and a coating comprising (a) black titania; (b) spinel; and (c) a hydrophobe; wherein a weight ratio of black titania to spinel ranges from about 99:1 to about 1:99, and all values in between, as stated above; and wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

A further aspect relates to a hydrophobic-coated overhead conductor comprising: a conductor comprising aluminum or an alloy thereof and a coating comprising (a) black titania; (b) spinel; and (c) a hydrophobe; wherein a weight ratio of black titania to spinel ranges from about 99:1 to about 1:99, and all values in between, as stated above; wherein the coating has a thickness of about 5 μm to about 100 μm, and all values in between, including about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm; and wherein a water droplet on the coating has a water contact angle of at least 90° and all values up to about 180°, including, for example about 85°, about 90°, about 95°, about 100°, about 105°, about 110°, about 115°, about 120°, about 125°, about 130°, about 140°, about 150°, about 160°, and about 170°.

Yet another aspect relates to a hydrophobic-coated overhead conductor comprising: a conductor comprising aluminum or an alloy thereof and a coating comprising (a) black titania, (b) cupric oxide, and (c) a hydrophobe.

A further aspect relates to a hydrophobic-coated overhead conductor comprising: a conductor comprising aluminum or an alloy thereof and a coating comprising (a) black titania, (b) cupric oxide, and (c) a hydrophobe; wherein a weight ratio of black titania to cupric oxide ranges from about 99:1 to about 50:50, including weight ratios of black titania to CuO of about 95:5, about 90:10, about 85:15, about 80:20, about 75:25, about 70:30, about 65:35, about 60:40, and about 55:45. In one aspect, the weight ratio of black titania to CuO may be about 99:1, about 95:5, about 5:1, and all values in between.

A further aspect relates to a hydrophobic-coated overhead conductor comprising: a conductor comprising aluminum or an alloy thereof and a coating comprising (a) black titania, (b) cupric oxide, and (c) a hydrophobe; wherein a weight ratio of black titania to cupric oxide ranges from about 99:1 to about 50:50 and all values in between, including weight ratios of black titania to CuO of about 95:5, about 90:10, about 85:15, about 80:20, about 75:25, about 70:30, about 65:35, about 60:40, about 55:45, and about 50:50; and wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

A further aspect relates to a hydrophobic-coated overhead conductor comprising: a conductor comprising aluminum or an alloy thereof and a coating comprising (a) black titania, (b) cupric oxide, and (c) a hydrophobe; wherein a weight ratio of black titania to cupric oxide ranges from about 99:1 to about 50:50 and all values in between, including weight ratios of black titania to CuO of about 95:5, about 90:10, about 85:15, about 80:20, about 75:25, about 70:30, about 65:35, about 60:40, about 55:45, and about 50:50; and wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm; and wherein a water droplet on the coating has a water contact angle of at least 90° and all values up to about 180°, including, for example about 85°, about 90°, about 95°, about 100°, about 105°, about 110°, about 115°, about 120°, about 125°, about 130°, about 140°, about 150°, about 160°, and about 170°.

Yet another aspect relates to a hydrophobic-coated overhead conductor comprising: a conductor comprising aluminum or an alloy thereof and a coating comprising (a) black titania, (b) magnetite, and (c) a hydrophobe.

A further aspect relates to a hydrophobic-coated overhead conductor comprising: a conductor comprising aluminum or an alloy thereof and a coating comprising (a) black titania, (b) magnetite, and (c) a hydrophobe; wherein a weight ratio of black titania to magnetite ranges from about 99:1 to about 50:50, and all values in between, including weight ratios of black titania to magnetite of about 95:5, about 90:10, about 85:15, about 80:20, about 75:25, about 70:30, about 65:35, about 60:40, and about 55:45. In one aspect, the weight ratio of black titania to magnetite may be about 35:1, about 20:1, about 10:1, about 5:1, and all values in between.

A further aspect relates to a hydrophobic-coated overhead conductor comprising: a conductor comprising aluminum or an alloy thereof and a coating comprising (a) black titania, (b) magnetite, and (c) a hydrophobe; wherein a weight ratio of black titania to magnetite ranges from about 99:1 to about 50:50, and all values in between, including weight ratios of black titania to magnetite of about 95:5, about 90:10, about 85:15, about 80:20, about 75:25, about 70:30, about 65:35, about 60:40, and about 55:45; and wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

A further aspect relates to a hydrophobic-coated overhead conductor comprising: a conductor comprising aluminum or an alloy thereof and a coating comprising (a) black titania, (b) magnetite, and (c) a hydrophobe; wherein a weight ratio of black titania to magnetite ranges from about 99:1 to about 50:50, and all values in between, including weight ratios of black titania to magnetite of about 95:5, about 90:10, about 85:15, about 80:20, about 75:25, about 70:30, about 65:35, about 60:40, and about 55:45; and wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm; and wherein a water droplet on the coating has a water contact angle of at least 90° and all values up to about 180°, including, for example about 85°, about 90°, about 95°, about 100°, about 105°, about 110°, about 115°, about 120°, about 125°, about 130°, about 140°, about 150°, about 160°, and about 170°.

### Fifth Aspect: Ceramic and Filler and Optionally Hydrophobe

A fifth aspect of the first embodiment relates to a coated overhead conductor comprising: a conductor comprising aluminum or an alloy thereof and a coating comprising (a) a ceramic; (b) a filler; and (c) optionally a hydrophobe.

A suitable ceramic includes a ceramic capable of melting without decomposition at a temperature used to generate a thermal spray. Examples of ceramics contemplated herein include, but are not limited to, alumina, magnetite, mullite, spinel, black titania, cupric oxide, or a combination thereof. The coating may include single or multiple (e.g., two or more) ceramics.

One aspect relates to a coated overhead conductor comprising: a conductor comprising aluminum or an alloy thereof and a coating comprising (a) a ceramic; (b) a filler; and (c) optionally a hydrophobe; wherein the ceramic comprises alumina, magnetite, mullite, spinel, black titania, cupric oxide, or a combination thereof.

One aspect relates to a coated overhead conductor comprising: a conductor comprising aluminum or an alloy thereof and a coating comprising (a) a ceramic; (b) a filler; and (c) optionally a hydrophobe; wherein the ceramic comprises alumina, magnetite, mullite, spinel, black titania, cupric oxide, or a combination thereof; and wherein the conductor comprises an ACSS, an ACCS, a ZTACCR, or a ZTACSR.

In one aspect, the filler may comprise a hydrophobic material, a pigment, or a combination thereof.

In one aspect, the filler may be a hydrophobic material (e.g., one or more of a rare earth metal compound (“REC”), a graphite, a graphene, a carbon nanotube (“CNT”), a hexagonal boron nitride (“hBN”)).

In another aspect, the filler may be a pigment (e.g., lamp black (“LB”), carbon black (“CB”), cupric oxide (CuO), an iron (II) oxide, an iron (III) oxide, an iron (II,III) oxide, or white titania (TiO₂).

In yet another aspect, the filler may comprise a hydrophobic material (e.g., REC, graphite, graphene, CNT, hBN, etc.) and a pigment (e.g., LB, CB, CuO, an iron (II) oxide, an iron (III) oxide, an iron (II,III) oxide) or white titania (TiO₂)). Examples of RECs contemplated herein include, but are not limited to, a rare earth metal oxide (REO), a rare earth metal phosphate (“REP”), and the like. REOs include, e.g., CeO₂, Pr₆O₁₁, Nd₂O₃, Sm₂O₃, Eu₂O₃, Gd₂O₃, Tb₄O₇, Dy₂O₃, Ho₂O₃, Er₂O₃, Tm₂O₃, Yb₂O₃, Lu₂O₃, La₂O₃. REPs include, e.g., LuPO₄, YbPO₄, TmPO₄, ErPO₄, HoPO₄, DyPO₄, TbPO₄, GdPO₄, EuPO₄, SmPO₄, NdPO₄, PrPO₄, CePO₄, and LaPO₄. Hydrophobicity of REOs and REPs may improve water repellency of the coating (see, e.g., Azimi and Sankar).

In this regard, an aspect relates to a coated overhead conductor comprising: a conductor comprising aluminum or an alloy thereof and a coating comprising (a) a ceramic; (b) a filler; and (c) optionally a hydrophobe; wherein the ceramic comprises alumina, magnetite, mullite, spinel, black titania, cupric oxide, or a combination thereof; and wherein the filler comprises a REC, a graphite, a graphene, a CNT, a hBN, a LB, a CB, CuO, an iron (II) oxide, an iron (III) oxide, an iron (II,III) oxide, white titania (TiO₂), or a combination thereof.

In the instance where the ceramic comprises a first ceramic and a second ceramic, the weight ratio of the first-to-second ceramics ranges from about 99:1 to about 1:99 and all values in between, including weight ratios of first ceramic to second ceramic of about 98:2, about 95:5, about 90:10, about 85:15, about 80:20, about 75:25, about 70:30, about 65:35, about 60:40, about 55:45, about 50:50, about 45:55, about 40:60, about 35:65, about 30:70, about 25:75, about 20:80, about 15:85, about 10:90, about 5:95, and about 2:98.

In the instance where the ceramic comprises a first ceramic, a second ceramic, and a third ceramic, the amounts for each of the ceramics sum to 100 parts by weight based on the total ceramic weight. One will appreciate the amount of each ceramic independently may vary from about 1% w/w to about 99% w/w based on the total weight of the ceramic. For instance, a ceramic comprising black titania, spinel, and alumina may comprise about 80% by weight of black titania, about 10% by weight of spinel, about 10% by weight of alumina.

In the instance where the ceramic comprises n-ceramics, one also will appreciate that a weight amount of ceramic may be f₁C₁+f₂C₂+ . . . fₙCₙ, where f₁, f₂, . . . fₙ represents the weight fraction of for each ceramic (C₁, C₂, . . . Cₙ).

A weight ratio of the ceramic to filler may vary depending on the desired property (e.g., hydrophobicity or pigmentation) of the coating. Generally, the coating has a weight ratio of ceramic to filler that ranges from about 99:1 to about 50:50 and all values in between, including weight ratios of ceramic to filler of about 90:10, about 85:15, about 80:20, about 75:25, about 70:30, about 65:35, about 60:40, about 55:45, and 50:50, etc.

In one aspect, a coating that comprises a ceramic and a filler has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

An aspect relates to a coated overhead conductor comprising: a conductor comprising aluminum or an alloy thereof and a coating comprising (a) black titania; (b) CeO₂; and (c) optionally a hydrophobe.

Yet another aspect relates to a coated overhead conductor comprising: a conductor comprising aluminum or an alloy thereof and a coating comprising (a) black titania; (b) CeO₂; and (c) optionally a hydrophobe; wherein a weight ratio of black titania to CeO₂ ranges from about 99:1 to about 50:50 and all values in between.

A further aspect relates to a coated overhead conductor comprising: a conductor comprising aluminum or an alloy thereof and a coating comprising (a) black titania; (b) CeO₂; and (c) optionally a hydrophobe; wherein a weight ratio of black titania to CeO₂ ranges from about 99:1 to about 50:50 and all values in between; and wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

Yet another aspect relates to a coated overhead conductor comprising: a conductor comprising aluminum or an alloy thereof and a coating comprising (a) black titania; (b) lamp black; and (c) optionally a hydrophobe.

A further aspect relates to a coated overhead conductor comprising: a conductor comprising aluminum or an alloy thereof and a coating comprising (a) black titania; (b) lamp black; and (c) optionally a hydrophobe; wherein a weight ratio of black titania to lamp black ranges from about 99:1 to about 50:50 and all values in between.

A further aspect relates to a coated overhead conductor comprising: a conductor comprising aluminum or an alloy thereof and a coating comprising (a) black titania; (b) lamp black; and (c) optionally a hydrophobe; wherein a weight ratio of black titania to lamp black ranges from about 99:1 to about 50:50 and all values in between; and wherein the coating has a thickness of about 5 μm to about 100 μm, and all values in between.

Yet another aspect relates to a coated overhead conductor comprising: a conductor comprising aluminum or an alloy thereof and a coating comprising (a) black titania; (b) hexagonal boron nitride; and (c) optionally a hydrophobe.

A further aspect relates to a coated overhead conductor comprising: a conductor comprising aluminum or an alloy thereof and a coating comprising (a) black titania; (b) hexagonal boron nitride; and (c) optionally a hydrophobe; wherein a weight ratio of black titania to hexagonal boron nitride ranges from about 99:1 to about 95:5 and all values in between. In certain instances, the weight ratio of black titania to hexagonal boron nitride may be about 99:1.

Yet another aspect relates to a coated overhead conductor comprising: a conductor comprising aluminum or an alloy thereof and a coating comprising (a) a ceramic comprising alumina, spinel, or a combination thereof; (b) a filler comprising graphene, lamp black, or a combination thereof; and (c) optionally a hydrophobe.

A further aspect relates to a coated overhead conductor comprising: a conductor comprising aluminum or an alloy thereof and a coating comprising (a) a ceramic comprising alumina, spinel, or a combination thereof; (b) a filler comprising graphene, lamp black, or a combination thereof; and (c) optionally a hydrophobe; wherein the weight ratio of ceramic to filler ranges from about 99:1 to about 95:5 and all values in between.

A further aspect relates to a coated overhead conductor comprising: a conductor comprising aluminum or an alloy thereof and a coating comprising (a) a ceramic comprising alumina, spinel, or a combination thereof; (b) a filler comprising graphene, lamp black, or a combination thereof; and (c) optionally a hydrophobe; wherein the weight ratio of ceramic to filler ranges from about 99:1 to about 95:5 and all values in between; and wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

Yet another aspect relates to a coated overhead conductor comprising: a conductor comprising aluminum or an alloy thereof and a coating comprising (a) a ceramic comprising black titania and spinel; (b) a filler comprising graphene, lamp black, CNT, iron (II,III) oxide, white titania (TiO₂), cupric oxide, or a combination thereof; and (c) optionally a hydrophobe.

A further aspect relates to a coated overhead conductor comprising: a conductor comprising aluminum or an alloy thereof and a coating comprising (a) a ceramic comprising black titania and spinel; (b) a filler comprising graphene, lamp black, CNT, iron (II,III) oxide, white titania (TiO₂), cupric oxide, or a combination thereof; and (c) optionally a hydrophobe; wherein a weight ratio of black titania to spinel ranges from about 99:1 to about 1:99 and all values in between, including weight ratios of black titania to spinel of about 98:2, about 95:5, about 90:10, about 85:15, about 80:20, about 75:25, about 70:30, about 65:35, about 60:40, about 55:45, about 50:50, about 45:55, about 40:60, about 35:65, about 30:70, about 25:75, about 20:80, about 15:85, about 10:90, about 5:95, and about 2:98.

A further aspect relates to a coated overhead conductor comprising: a conductor comprising aluminum or an alloy thereof and a coating comprising (a) a ceramic comprising black titania and spinel; (b) a filler comprising graphene, lamp black, CNT, iron (II,III) oxide, white titania (TiO₂), cupric oxide, or a combination thereof; and (c) optionally a hydrophobe; wherein a weight ratio of black titania to spinel ranges from about 99:1 to about 1:99 and all values in between, including weight ratios of black titania to spinel of about 98:2, about 95:5, about 90:10, about 85:15, about 80:20, about 75:25, about 70:30, about 65:35, about 60:40, about 55:45, about 50:50, about 45:55, about 40:60, about 35:65, about 30:70, about 25:75, about 20:80, about 15:85, about 10:90, about 5:95, and about 2:98; and wherein a weight ratio of ceramic to filler ranges from about 98:2 to about 50:50 and all values in between, including weight ratios of ceramic to filler of about 90:10, about 85:15, about 80:20, about 75:25, about 70:30, about 65:35, about 60:40, about 55:45, and about 50:50.

A further aspect relates to a coated overhead conductor comprising: a conductor comprising aluminum or an alloy thereof and a coating comprising (a) a ceramic comprising black titania and spinel; (b) a filler comprising graphene, lamp black, CNT, an iron (II) oxide, an iron (III) oxide, an iron (II,III) oxide, white titania (TiO₂), cupric oxide, or a combination thereof; and (c) optionally a hydrophobe; wherein a weight ratio of black titania to spinel ranges from about 99:1 to about 1:99 and all values in between, including weight ratios of black titania to spinel of about 98:2, about 95:5, about 90:10, about 85:15, about 80:20, about 75:25, about 70:30, about 65:35, about 60:40, about 55:45, about 50:50, about 45:55, about 40:60, about 35:65, about 30:70, about 25:75, about 20:80, about 15:85, about 10:90, about 5:95, and about 2:98; wherein a weight ratio of ceramic to filler ranges from about 98:2 to about 50:50 and all values in between, including weight ratios of ceramic to filler of about 90:10, about 85:15, about 80:20, about 75:25, about 70:30, about 65:35, about 60:40, about 55:45, and about 50:50; and wherein a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 10 μm to about 60 μm or the coating may have a thickness of about 20 μm or about 50 μm.

### Sixth Aspect: Ceramic and Filler and Hydrophobe

A sixth aspect of the first embodiment relates to a hydrophobic-coated overhead conductor comprising: a conductor comprising aluminum or an alloy thereof and a coating comprising (a) a ceramic; (b) a filler; and (c) a hydrophobe.

A suitable ceramic includes a ceramic capable of melting without decomposition at a temperature used to generate a thermal spray. Examples of ceramics contemplated herein include, but are not limited to, alumina, magnetite, mullite, spinel, black titania, and cupric oxide. The coating may include single or multiple (e.g., two or more) ceramics.

One aspect relates to a hydrophobic-coated overhead conductor comprising: a conductor comprising aluminum or an alloy thereof and a coating comprising (a) a ceramic; (b) a filler; and (c) a hydrophobe; wherein the ceramic comprises alumina, magnetite, mullite, spinel, black titania, cupric oxide, or a combination thereof.

One aspect relates to a hydrophobic-coated overhead conductor comprising: a conductor comprising aluminum or an alloy thereof and a coating comprising (a) a ceramic; (b) a filler; and (c) a hydrophobe; wherein the ceramic comprises alumina, magnetite, mullite, spinel, black titania, cupric oxide, or a combination thereof; and wherein the conductor comprises an ACSS, an ACCS, a ZTACCR, or a ZTACSR.

In one aspect, the filler may comprise a hydrophobic material, a pigment, or a combination thereof.

In another aspect, the filler may be a hydrophobic material (e.g., one or more of a rare earth metal compound (“REC”), a graphite, a graphene, a carbon nanotube (“CNT”), a hexagonal boron nitride (“hBN”)).

In another aspect, the filler may be a pigment (e.g., lamp black (“LB”), carbon black (“CB”), cupric oxide (CuO), an iron (II) oxide, an iron (III) oxide, an iron (II,III) oxide), or white titania (TiO₂).

In yet another aspect, the filler may comprise a hydrophobic material (e.g., REC, graphite, graphene, CNT, hBN, etc.) and a pigment (e.g., LB, CB, CuO, an iron (II) oxide, an iron (III) oxide, an iron (II,III) oxide), or white titania (TiO₂)).

Examples of RECs contemplated herein include, but are not limited to, a rare earth metal oxide (REO), a rare earth metal phosphate (“REP”), and the like. REOs include, e.g., CeO₂, Pr₆O₁₁, Nd₂O₃, Sm₂O₃, Eu₂O₃, Gd₂O₃, Tb₄O₇, Dy₂O₃, Ho₂O₃, Er₂O₃, Tm₂O₃, Yb₂O₃, Lu₂O₃, La₂O₃. REPs include, e.g., LuPO₄, YbPO₄, TmPO₄, ErPO₄, HoPO₄, DyPO₄, TbPO₄, GdPO₄, EuPO₄, SmPO₄, NdPO₄, PrPO₄, CePO₄, and LaPO₄. Hydrophobicity of REOs and REPs may improve water repellency of the coating (see, e.g., Azimi and Sankar).

In this regard, an aspect relates to a hydrophobic-coated overhead conductor comprising: a conductor comprising aluminum or an alloy thereof and a coating comprising (a) a ceramic; (b) a filler; and (c) a hydrophobe; wherein the ceramic comprises alumina, magnetite, mullite, spinel, black titania, cupric oxide, or a combination thereof; and wherein the filler comprises a REC, a graphite, a graphene, a CNT, a hBN, a LB, a CB, CuO, an iron (II) oxide, an iron (III) oxide, an iron (II,III) oxide, white titania (TiO₂), or a combination thereof.

In the instance where the ceramic comprises a first ceramic and a second ceramic, the weight ratio of the first-to-second ceramics ranges from about 99:1 to about 1:99 and all values in between, including weight ratios of first ceramic to second ceramic of about 98:2, about 95:5, about 90:10, about 85:15, about 80:20, about 75:25, about 70:30, about 65:35, about 60:40, about 55:45, about 50:50, about 45:55, about 40:60, about 35:65, about 30:70, about 25:75, about 20:80, about 15:85, about 10:90, about 5:95, and about 2:98.

In the instance where the ceramic comprises a first ceramic, a second ceramic, and a third ceramic, the amounts for each of the ceramics sum to 100 parts by weight based on the total ceramic weight. One will appreciate the amount of each ceramic independently may vary from about 1% w/w to about 99% w/w based on the total weight of the ceramic. For instance, a ceramic comprising black titania, spinel, and alumina may comprise about 80% by weight of black titania, about 10% by weight of spinel, about 10% by weight of alumina.

In the instance where the ceramic comprises n-ceramics, one also will appreciate that a weight amount of ceramic may be f₁C₁+f₂C₂+ . . . fₙCₙ, where f₁, f₂, . . . fₙ represents the weight fraction of for each ceramic (C₁, C₂, . . . Cₙ).

A weight ratio of the ceramic to filler may vary depending on the desired property (e.g., hydrophobicity or pigmentation) of the coating. Generally, the coating has a weight ratio of ceramic-to-filler that ranges from about 99:1 to about 50:50 and all values in between, including weight ratios of ceramic-to-filler of about 95:5, about 90:10, about 85:15, about 80:20, about 75:25, about 70:30, about 65:35, about 60:40, about 55:45, and 50:50, etc.

In one aspect, a coating that comprises a ceramic and a filler has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 10 μm to about 60 μm or the coating may have a thickness of about 20 μm or about 50 μm.

An aspect relates to a hydrophobic-coated overhead conductor comprising: a conductor comprising aluminum or an alloy thereof and a coating comprising (a) black titania; (b) CeO₂; and (c) a hydrophobe.

Yet another aspect relates to a hydrophobic-coated overhead conductor comprising: a conductor comprising aluminum or an alloy thereof and a coating comprising (a) black titania; (b) CeO₂; and (c) a hydrophobe; wherein a weight ratio of black titania to CeO₂ ranges from about 98:2 to about 50:50 and all values in between.

A further aspect relates to a hydrophobic-coated overhead conductor comprising: a conductor comprising aluminum or an alloy thereof and a coating comprising (a) black titania; (b) CeO₂; and (c) a hydrophobe; wherein a weight ratio of black titania to CeO₂ ranges from about 98:2 to about 50:50 and all values in between; and wherein the coating has a thickness of about 5 μm to about 100 μm, and all values in between, including about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

A further aspect relates to a hydrophobic-coated overhead conductor comprising: a conductor comprising aluminum or an alloy thereof and a coating comprising (a) black titania; (b) CeO₂; and (c) a hydrophobe; wherein a weight ratio of black titania to CeO₂ ranges from about 98:2 to about 50:50 and all values in between; and wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 10 μm to about 60 μm or the coating may have a thickness of about 20 μm or about 50 μm; and wherein a water droplet on the coating has a water contact angle of at least 90° and all values up to about 180°, including, for example about 85°, about 90°, about 95°, about 100°, about 105°, about 110°, about 115°, about 120°, about 125°, about 130°, about 140°, about 150°, about 160°, and about 170°.

Yet another aspect relates to a hydrophobic-coated overhead conductor comprising: a conductor comprising aluminum or an alloy thereof and a coating comprising (a) black titania; (b) lamp black; and (c) a hydrophobe.

A further aspect relates to a hydrophobic-coated overhead conductor comprising: a conductor comprising aluminum or an alloy thereof and a coating comprising (a) black titania; (b) lamp black; and (c) a hydrophobe; wherein a weight ratio of black titania to lamp black ranges from about 98:2 to about 50:50 and all values in between.

A further aspect relates to a hydrophobic-coated overhead conductor comprising: a conductor comprising aluminum or an alloy thereof and a coating comprising (a) black titania; (b) lamp black; and (c) a hydrophobe; wherein a weight ratio of black titania to lamp black ranges from about 98:2 to about 50:50 and all values in between; and wherein the coating has a thickness of about 5 μm to about 100 μm, and all values in between.

A further aspect relates to a hydrophobic-coated overhead conductor comprising: a conductor comprising aluminum or an alloy thereof and a coating comprising (a) black titania; (b) lamp black; and (c) a hydrophobe; wherein a weight ratio of black titania to lamp black ranges from about 98:2 to about 50:50 and all values in between; and wherein the coating has a thickness of about 5 μm to about 100 μm, and all values in between; and wherein a water droplet on the coating has a water contact angle of at least 90° and all values up to about 180°, including, for example about 85°, about 90°, about 95°, about 100°, about 105°, about 110°, about 115°, about 120°, about 125°, about 130°, about 140°, about 150°, about 160°, and about 170°.

Yet another aspect relates to a hydrophobic-coated overhead conductor comprising: a conductor comprising aluminum or an alloy thereof and a coating comprising (a) black titania; (b) hexagonal boron nitride; and (c) a hydrophobe.

A further aspect relates to a hydrophobic-coated overhead conductor comprising: a conductor comprising aluminum or an alloy thereof and a coating comprising (a) black titania; (b) hexagonal boron nitride; and (c) a hydrophobe; wherein a weight ratio of black titania to hexagonal boron nitride ranges from about 99:2 to about 95:5 and all values in between.

A further aspect relates to a hydrophobic-coated overhead conductor comprising: a conductor comprising aluminum or an alloy thereof and a coating comprising (a) black titania; (b) hexagonal boron nitride; and (c) a hydrophobe; wherein a weight ratio of black titania to hexagonal boron nitride ranges from about 99:1 to about 95:5 and all values in between; and wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

A further aspect relates to a hydrophobic-coated overhead conductor comprising: a conductor comprising aluminum or an alloy thereof and a coating comprising (a) black titania; (b) hexagonal boron nitride; and (c) a hydrophobe; wherein a weight ratio of black titania to hexagonal boron nitride ranges from about 99:1 to about 95:5 and all values in between; and wherein the coating has a thickness of about 5 μm to about 100 μm, and all values in between; and wherein a water droplet on the coating has a water contact angle of at least 90° and all values up to about 180°, including, for example about 85°, about 90°, about 95°, about 100°, about 105°, about 110°, about 115°, about 120°, about 125°, about 130°, about 140°, about 150°, about 160°, and about 170°.

Yet another aspect relates to a hydrophobic-coated overhead conductor comprising: a conductor comprising aluminum or an alloy thereof and a coating comprising (a) a ceramic comprising alumina, spinel, or a combination thereof; (b) a filler comprising graphene, lamp black, or a combination thereof; and (c) a hydrophobe.

A further aspect relates to a hydrophobic-coated overhead conductor comprising: a conductor comprising aluminum or an alloy thereof and a coating comprising (a) a ceramic comprising alumina, spinel, or a combination thereof; (b) a filler comprising graphene, lamp black, or a combination thereof; and (c) a hydrophobe; wherein the weight ratio of ceramic-tofiller ranges from about 99:1 to about 95:5 and all values in between.

A further aspect relates to a hydrophobic-coated overhead conductor comprising: a conductor comprising aluminum or an alloy thereof and a coating comprising (a) a ceramic comprising alumina, spinel, or a combination thereof; (b) a filler comprising graphene, lamp black, or a combination thereof; and (c) a hydrophobe; wherein the weight ratio of ceramic-to-filler ranges from about 99:1 to about 95:5 and all values in between; and wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

A further aspect relates to a hydrophobic-coated overhead conductor comprising: a conductor comprising aluminum or an alloy thereof and a coating comprising (a) a ceramic comprising alumina, spinel, or a combination thereof; (b) a filler comprising graphene, lamp black, or a combination thereof; and (c) a hydrophobe; wherein the weight ratio of ceramic to filler ranges from about 99:1 to about 95:5 and all values in between; and wherein the coating has a thickness of about 5 μm to about 100 μm, and all values in between; wherein a water droplet on the coating has a water contact angle of at least 90° and all values up to about 180°, including, for example about 85°, about 90°, about 95°, about 100°, about 105°, about 110°, about 115°, about 120°, about 125°, about 130°, about 140°, about 150°, about 160°, and about 170°.

Yet another aspect relates to a hydrophobic-coated overhead conductor comprising: a conductor comprising aluminum or an alloy thereof and a coating comprising (a) a ceramic comprising black titania and spinel; (b) a filler comprising graphene, lamp black, CNT, iron (II, III) oxide, white titania (TiO₂), cupric oxide, or a combination thereof; and (c) a hydrophobe.

A further aspect relates to a hydrophobic-coated overhead conductor comprising: a conductor comprising aluminum or an alloy thereof and a coating comprising (a) a ceramic comprising black titania and spinel; (b) a filler comprising graphene, lamp black, CNT, iron (II,III) oxide, white titania (TiO₂), cupric oxide, or a combination thereof; and (c) a hydrophobe; wherein a weight ratio of black titania to spinel ranges from about 99:1 to about 1:99 and all values in between, including weight ratios of black titania to spinel of about 98:2, about 95:5, about 90:10, about 85:15, about 80:20, about 75:25, about 70:30, about 65:35, about 60:40, about 55:45, about 50:50, about 45:55, about 40:60, about 35:65, about 30:70, about 25:75, about 20:80, about 15:85, about 10:90, about 5:95, and about 2:98.

A further aspect relates to a hydrophobic-coated overhead conductor comprising: a conductor comprising aluminum or an alloy thereof and a coating comprising (a) a ceramic comprising black titania and spinel; (b) a filler comprising graphene, lamp black, CNT, iron (II,III) oxide, white titania (TiO₂), cupric oxide, or a combination thereof; and (c) a hydrophobe; wherein a weight ratio of black titania to spinel ranges from about 99:1 to about 1:99 and all values in between, including weight ratios of black titania to spinel of about 98:2, about 95:5, about 90:10, about 85:15, about 80:20, about 75:25, about 70:30, about 65:35, about 60:40, about 55:45, about 50:50, about 45:55, about 40:60, about 35:65, about 30:70, about 25:75, about 20:80, about 15:85, about 10:90, about 5:95, and about 2:98; and wherein a weight ratio of ceramic to filler ranges from about 98:2 to about 50:50 and all values in between, including weight ratios of ceramic to filler of about 90:10, about 85:15, about 80:20, about 75:25, about 70:30, about 65:35, about 60:40, about 55:45, and about 50:50.

A further aspect relates to a hydrophobic-coated overhead conductor comprising: a conductor comprising aluminum or an alloy thereof and a coating comprising (a) a ceramic comprising black titania and spinel; (b) a filler comprising graphene, lamp black, CNT, an iron (II) oxide, an iron (III) oxide, an iron (II,III) oxide, white titania (TiO₂), cupric oxide, or a combination thereof; and (c) a hydrophobe; wherein a weight ratio of black titania to spinel ranges from about 99:1 to about 1:99 and all values in between, including weight ratios of black titania to spinel of about 98:2, about 95:5, about 90:10, about 85:15, about 80:20, about 75:25, about 70:30, about 65:35, about 60:40, about 55:45, about 50:50, about 45:55, about 40:60, about 35:65, about 30:70, about 25:75, about 20:80, about 15:85, about 10:90, about 5:95, and about 2:98; wherein a weight ratio of ceramic to filler ranges from about 98:2 to about 50:50 and all values in between, including weight ratios of ceramic to filler of about 90:10, about 85:15, about 80:20, about 75:25, about 70:30, about 65:35, about 60:40, about 55:45, and about 50:50; and wherein a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

A further aspect relates to a hydrophobic-coated overhead conductor comprising: a conductor comprising aluminum or an alloy thereof and a coating comprising (a) a ceramic comprising black titania and spinel; (b) a filler comprising graphene, lamp black, CNT, an iron (II) oxide, an iron (III) oxide, an iron (II,III) oxide, white titania (TiO₂), cupric oxide, or a combination thereof; and (c) a hydrophobe; wherein a weight ratio of black titania to spinel ranges from about 99:1 to about 1:99 and all values in between, including weight ratios of black titania to spinel of about 98:2, about 95:5, about 90:10, about 85:15, about 80:20, about 75:25, about 70:30, about 65:35, about 60:40, about 55:45, about 50:50, about 45:55, about 40:60, about 35:65, about 30:70, about 25:75, about 20:80, about 15:85, about 10:90, about 5:95, and about 2:98; wherein a weight ratio of ceramic to filler ranges from about 98:2 to about 50:50 and all values in between, including weight ratios of ceramic to filler of about 90:10, about 85:15, about 80:20, about 75:25, about 70:30, about 65:35, about 60:40, about 55:45, and about 50:50; and wherein a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm; and wherein a water droplet on the coating has a water contact angle of at least 90° and all values up to about 180°, including, for example about 85°, about 90°, about 95°, about 100°, about 105°, about 110°, about 115°, about 120°, about 125°, about 130°, about 140°, about 150°, about 160°, and about 170°.

### Seventh Aspect: Aluminum and Filler and Optionally Hydrophobe

A seventh aspect of the first embodiment relates to a coated overhead conductor comprising: a conductor comprising aluminum or an alloy thereof and a coating comprising (a) an aluminum; (b) a filler; and (c) optionally a hydrophobe.

A coating comprising an aluminum contemplated herein includes aluminum and an aluminum alloy (collectively the “coating-aluminum”), e.g., Al 99.5%, Al (99.0%), Al-5% Mg, Al-12% Si), and the like. For instance, an aluminum powder contemplated herein may be obtained commercially from Inoxia Ltd. having a particle size of less than about 250 mesh and a purity of about 99.5%. Again, the coating-aluminum elemental composition may be the same or different from the conductor-aluminum (or conductor aluminum alloy) elemental composition.

One aspect relates to a coated overhead conductor comprising: a conductor comprising aluminum or an alloy thereof and a coating comprising (a) an aluminum; (b) a filler; and (c) optionally a hydrophobe; wherein the conductor comprises an ACSS, an ACCS, a ZTACCR, or a ZTACSR.

In one aspect, the filler may be a hydrophobic material (e.g., one or more of a rare earth metal compound (“REC”), a graphite, a graphene, a carbon nanotube (“CNT”), a hexagonal boron nitride (“hBN”). In another aspect, the filler may be a pigment (e.g., lamp black (“LB”), carbon black (“CB”), cupric oxide (CuO), an iron (II) oxide, an iron (III) oxide, an iron (II,III) oxide), or white titania (TiO₂). In yet another aspect, the filler may comprise a hydrophobic material (e.g., REC, graphite, graphene, CNT, hBN, etc.) and a pigment (e.g., LB, CB, CuO, an iron (II) oxide, an iron (III) oxide, an iron (II,III) oxide), or white titania (TiO₂).

Examples of RECs contemplated herein include, but are not limited to, a rare earth metal oxide (REO), a rare earth metal phosphate (“REP”), and the like. REOs include, e.g., CeO₂, Pr₆O₁₁, Nd₂O₃, Sm₂O₃, Eu₂O₃, Gd₂O₃, Tb₄O₇, Dy₂O₃, Ho₂O₃, Er₂O₃, Tm₂O₃, Yb₂O₃, Lu₂O₃, La₂O₃. REPs include, e.g., LuPO₄, YbPO₄, TmPO₄, ErPO₄, HoPO₄, DyPO₄, TbPO₄, GdPO₄, EuPO₄, SmPO₄, NdPO₄, PrPO₄, CePO₄, and LaPO₄. Hydrophobicity of REOs and REPs may improve water repellency of the coating (see, e.g., Azimi and Sankar).

In this regard, an aspect relates to a coated overhead conductor comprising: a conductor comprising aluminum or an alloy thereof and a coating comprising (a) an aluminum; (b) a filler; and (c) optionally a hydrophobe; wherein the filler comprises a REC, a graphite, a graphene, a CNT, a hBN, a LB, a CB, CuO, an iron (II) oxide, an iron (III) oxide, an iron (II,III) oxide, white titania (TiO₂), or a combination thereof.

A weight ratio of the aluminum to filler may vary depending on the desired property (e.g., hydrophobicity or pigmentation) of the coating. Generally, the coating has a weight ratio of aluminum to filler that ranges from about 99:1 to about 50:50 and all values in between, including weight ratios of aluminum to filler of about 95:5, about 90:10, about 85:15, about 80:20, about 75:25, about 70:30, about 65:35, about 60:40, and about 55:45.

In one aspect, a coating that comprises an aluminum and a filler has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

An aspect relates to a coated overhead conductor comprising: a conductor comprising aluminum or an alloy thereof and a coating comprising (a) aluminum; (b) cupric oxide; and (c) optionally a hydrophobe.

Yet another aspect relates to a coated overhead conductor comprising: a conductor comprising aluminum or an alloy thereof and a coating comprising (a) aluminum; (b) cupric oxide; and (c) optionally a hydrophobe; wherein a weight ratio of aluminum to CuO ranges from about 99:1 to about 50:50 and all values in between.

A further aspect relates to a coated overhead conductor comprising: a conductor comprising aluminum or an alloy thereof and a coating comprising (a) aluminum; (b) cupric oxide; and (c) optionally a hydrophobe; wherein a weight ratio of aluminum to CuO ranges from about 99:1 to about 50:50 and all values in between; and wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

Yet another aspect relates to a coated overhead conductor comprising: a conductor comprising aluminum or an alloy thereof and a coating comprising (a) aluminum; (b) lamp black; and (c) optionally a hydrophobe.

A further aspect relates to a coated overhead conductor comprising: a conductor comprising aluminum or an alloy thereof and a coating comprising (a) aluminum; (b) lamp black; and (c) optionally a hydrophobe; wherein a weight ratio of aluminum to lamp black ranges from about 99:1 to about 50:50 and all values in between.

A further aspect relates to a coated overhead conductor comprising: a conductor comprising aluminum or an alloy thereof and a coating comprising (a) aluminum; (b) lamp black; and (c) optionally a hydrophobe; wherein a weight ratio of aluminum to lamp black ranges from about 99:1 to about 50:50 and all values in between; and wherein the coating has a thickness of about 5 μm to about 100 μm, and all values in between.

Yet another aspect relates to a coated overhead conductor comprising: a conductor comprising aluminum or an alloy thereof and a coating comprising (a) aluminum; (b) hexagonal boron nitride; and (c) optionally a hydrophobe.

A further aspect relates to a coated overhead conductor comprising: a conductor comprising aluminum or an alloy thereof and a coating comprising (a) aluminum; (b) hexagonal boron nitride; and (c) optionally a hydrophobe; wherein a weight ratio of aluminum to hexagonal boron nitride ranges from about 99:1 to about 90:10 and all values in between. In certain instances, the weight ratio of aluminum to hexagonal boron nitride may be about 95:5.

A further aspect relates to a coated overhead conductor comprising: a conductor comprising aluminum or an alloy thereof and a coating comprising (a) aluminum; (b) hexagonal boron nitride; and (c) optionally a hydrophobe; wherein a weight ratio of aluminum to hexagonal boron nitride ranges from about 99:1 to about 90:10 and all values in between. In certain instances, the weight ratio of aluminum to hexagonal boron nitride may be about 95:5; and wherein the coating has a thickness of about 5 μm to about 100 μm, and all values in between.

### Eighth Aspect: Aluminum and Filler and Hydrophobe

An eighth aspect of the first embodiment relates to a hydrophobic-coated overhead conductor comprising: a conductor comprising aluminum or an alloy thereof and a coating comprising (a) an aluminum; (b) a filler; and (c) a hydrophobe.

A coating comprising an aluminum contemplated herein includes aluminum and an aluminum alloy (collectively the “coating-aluminum”), e.g., Al 99.5%, Al (99.0%), Al-5% Mg, Al-12% Si), and the like. For instance, an aluminum powder contemplated herein may be obtained commercially from Inoxia Ltd. Particle size <250 mesh; Purity 99.5%. Again, the coating-aluminum elemental composition may be the same or different from the conductor-aluminum (or conductor aluminum alloy) elemental composition.

One aspect relates to a hydrophobic-coated overhead conductor comprising: a conductor comprising aluminum or an alloy thereof and a coating comprising (a) an aluminum; (b) a filler; and (c) a hydrophobe; wherein the conductor comprises an ACSS, an ACCS, a ZTACCR, or a ZTACSR.

In one aspect, the filler may be a hydrophobic material (e.g., one or more of a rare earth metal compound (“REC”), a graphite, a graphene, a carbon nanotube (“CNT”), a hexagonal boron nitride (“hBN”). In another aspect, the filler may be a pigment (e.g., lamp black (“LB”), carbon black (“CB”), cupric oxide (CuO), an iron (II) oxide, an iron (III) oxide, an iron (II,III) oxide), or white titania (TiO₂)). In yet another aspect, the filler may comprise a hydrophobic material (e.g., REC, graphite, graphene, CNT, hBN, etc.) and a pigment (e.g., LB, CB, CuO, an iron (II) oxide, an iron (III) oxide, an iron (II,III) oxide), or white titania (TiO₂)).

Examples of RECs contemplated herein include, but are not limited to, a rare earth metal oxide (REO), a rare earth metal phosphate (“REP”), and the like. REOs include, e.g., CeO₂, Pr₆O₁₁, Nd₂O₃, Sm₂O₃, Eu₂O₃, Gd₂O₃, Tb₄O₇, Dy₂O₃, Ho₂O₃, Er₂O₃, Tm₂O₃, Yb₂O₃, Lu₂O₃, La₂O₃. REPs include, e.g., LuPO₄, YbPO₄, TmPO₄, ErPO₄, HoPO₄, DyPO₄, TbPO₄, GdPO₄, EuPO₄, SmPO₄, NdPO₄, PrPO₄, CePO₄, and LaPO₄. Hydrophobicity of REOs and REPs may improve water repellency of the coating (see, e.g., Azimi and Sankar).

In this regard, an aspect relates to a hydrophobic-coated overhead conductor comprising: a conductor comprising aluminum or an alloy thereof and a coating comprising (a) an aluminum; (b) a filler; and (c) a hydrophobe; wherein the filler comprises a REC, a graphite, a graphene, a CNT, a hBN, a LB, a CB, CuO, an iron (II) oxide, an iron (III) oxide, an iron (II,III) oxide, white titania (TiO₂), or a combination thereof.

A weight ratio of the aluminum to filler may vary depending on the desired property (e.g., hydrophobicity or pigmentation) of the coating. Generally, the coating has a weight ratio of aluminum to filler that ranges from about 99:1 to about 50:50 and all values in between, including weight ratios of aluminum to filler of about 95:5, about 90:10, about 85:15, about 80:20, about 75:25, about 70:30, about 65:35, about 60:40, and about 55:45.

In one aspect, a coating that comprises an aluminum and a filler has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

An aspect relates to a hydrophobic-coated overhead conductor comprising: a conductor comprising aluminum or an alloy thereof and a coating comprising (a) aluminum; (b) cupric oxide; and (c) a hydrophobe.

Yet another aspect relates to a hydrophobic-coated overhead conductor comprising: a conductor comprising aluminum or an alloy thereof and a coating comprising (a) aluminum; (b) cupric oxide; and (c) a hydrophobe; wherein a weight ratio of aluminum to CuO ranges from about 99:1 to about 50:50 and all values in between.

A further aspect relates to a hydrophobic-coated overhead conductor comprising: a conductor comprising aluminum or an alloy thereof and a coating comprising (a) aluminum; (b) cupric oxide; and (c) a hydrophobe; wherein a weight ratio of aluminum to CuO ranges from about 99:1 to about 50:50 and all values in between; and wherein the coating has a thickness of about 5 μm to about 100 μm, and all values in between, including about 10 μm, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. For instance, the coating may have a thickness that ranges from about 5 μm to about 30 μm, from about 10 μm to about 20 μm, from about 10 μm to about 60 μm or the coating may have a thickness of about 20 μm or about 50 μm.

A further aspect relates to a hydrophobic-coated overhead conductor comprising: a conductor comprising aluminum or an alloy thereof and a coating comprising (a) aluminum; (b) cupric oxide; and (c) a hydrophobe; wherein a weight ratio of aluminum to CuO ranges from about 99:1 to about 50:50 and all values in between; wherein a water droplet on the coating has a water contact angle of at least 90° and all values up to about 180°, including, for example about 85°, about 90°, about 95°, about 100°, about 105°, about 110°, about 115°, about 120°, about 125°, about 130°, about 140°, about 150°, about 160°, and about 170°.

A further aspect relates to a hydrophobic-coated overhead conductor comprising: a conductor comprising aluminum or an alloy thereof and a coating comprising (a) aluminum; (b) cupric oxide; and (c) a hydrophobe; wherein a weight ratio of aluminum to CuO ranges from about 99:1 to about 50:50 and all values in between; wherein the coating has a thickness of about 5 μm to about 100 μm, and all values in between, and wherein a water droplet on the coating has a water contact angle of at least 90° and all values up to about 180°, including, for example about 85°, about 90°, about 95°, about 100°, about 105°, about 110°, about 115°, about 120°, about 125°, about 130°, about 140°, about 150°, about 160°, and about 170°.

Yet another aspect relates to a hydrophobic-coated overhead conductor comprising: a conductor comprising aluminum or an alloy thereof and a coating comprising (a) aluminum; (b) lamp black; and (c) a hydrophobe.

A further aspect relates to a hydrophobic-coated overhead conductor comprising: a conductor comprising aluminum or an alloy thereof and a coating comprising (a) aluminum; (b) lamp black; and (c) a hydrophobe; wherein a weight ratio of aluminum to lamp black ranges from about 99:1 to about 50:50 and all values in between.

A further aspect relates to a hydrophobic-coated overhead conductor comprising: a conductor comprising aluminum or an alloy thereof and a coating comprising (a) aluminum; (b) lamp black; and (c) a hydrophobe; wherein a weight ratio of aluminum to lamp black ranges from about 99:1 to about 50:50 and all values in between; and wherein the coating has a thickness of about 5 μm to about 100 μm, and all values in between.

A further aspect relates to a hydrophobic-coated overhead conductor comprising: a conductor comprising aluminum or an alloy thereof and a coating comprising (a) aluminum; (b) lamp black; and (c) a hydrophobe; wherein a weight ratio of aluminum to lamp black ranges from about 99:1 to about 50:50 and all values in between; and wherein the coating has a thickness of about 5 μm to about 100 μm, and all values in between; and wherein a water droplet on the coating has a water contact angle of at least 90° and all values up to about 180°, including, for example about 85°, about 90°, about 95°, about 100°, about 105°, about 110°, about 115°, about 120°, about 125°, about 130°, about 140°, about 150°, about 160°, and about 170°.

Yet another aspect relates to a coated overhead conductor comprising: a conductor comprising aluminum or an alloy thereof and a coating comprising (a) aluminum; (b) hexagonal boron nitride; and (c) a hydrophobe.

A further aspect relates to a hydrophobic-coated overhead conductor comprising: a conductor comprising aluminum or an alloy thereof and a coating comprising (a) aluminum; (b) hexagonal boron nitride; and (c) a hydrophobe; wherein a weight ratio of aluminum to hexagonal boron nitride ranges from about 99:1 to about 90:10 and all values in between. In certain instances, the weight ratio of aluminum to hexagonal boron nitride may be about 95:5.

A further aspect relates to a hydrophobic-coated overhead conductor comprising: a conductor comprising aluminum or an alloy thereof and a coating comprising (a) aluminum; (b) hexagonal boron nitride; and (c) optionally a hydrophobe; wherein a weight ratio of aluminum to hexagonal boron nitride ranges from about 99:1 to about 90:10 and all values in between. In certain instances, the weight ratio of aluminum to hexagonal boron nitride may be about 95:5; and wherein the coating has a thickness of about 5 μm to about 100 μm, and all values in between.

A further aspect relates to a hydrophobic-coated overhead conductor comprising: a conductor comprising aluminum or an alloy thereof and a coating comprising (a) aluminum; (b) hexagonal boron nitride; and (c) optionally a hydrophobe; wherein a weight ratio of aluminum to hexagonal boron nitride ranges from about 99:1 to about 90:10 and all values in between; and wherein a water droplet on the coating has a water contact angle of at least 90° and all values up to about 180°, including, for example about 85°, about 90°, about 95°, about 100°, about 105°, about 110°, about 115°, about 120°, about 125°, about 130°, about 140°, about 150°, about 160°, and about 170°.

### Second Embodiment: Process for Preparing Coated Overhead Aluminum Conductor

A second embodiment relates to a process for preparing the coated overhead conductor of the first embodiment including aspects thereof.

The coated overhead conductor may be prepared in in several ways. For instance, the coated overhead conductor may be prepared by applying the coating (and optionally the hydrophobe) to individual wires before stranding to provide the coated overhead conductor. For instance, the outermost (or peripheral) wires of the conductor may be coated. Alternatively, the coating (and optionally the hydrophobe) may be applied (completely or partially) to the outer surface of the uncoated, conductor. The coating may be applied via a batch process, a semi-batch process, or a continuous process.

The process of the second embodiment comprises: (i) providing an uncoated conductor; (ii) heating the surface of the uncoated conductor to a temperature of from about 200° C. to about 500° C. to obtain a pre-heated, uncoated conductor; (iii) depositing by thermally spraying the ceramic, the filler, the aluminum, or a combination thereof on the pre-heated, uncoated conductor to obtain the coated conductor; and (iv) optionally applying a hydrophobe or a hydrophobe precursor to the coated conductor.

Again, the uncoated conductor contemplated herein relates generally to high-temperature applications, including, but not limited to ACSS, ACCS, ZTACCR, ZTACSR, and the like.

In one aspect, the method of the second embodiment operates by a continuous process. In a continuous process, the uncoated/coated conductor may be drawn through a collection of operational zones at a rate of about 10 cm/s to about 100 cm/s and all values in between, including, for example, about 20 cm/s, about 25 cm/s, about 30 cm/s, about 35 cm/s, about 40 cm/s, about 45 cm/s, about 50 cm/s, about 55 cm/s, about 60 cm/s, about 65 cm/s, about 70 cm/s, about 75 cm/s, about 80 cm/s, about 85 cm/s, about 90 cm/s, and about 95 cm/s. In one aspect, the uncoated/coated conductor may be drawn through the collection of operational zones at a rate of about 40 cm/s to about 60 cm/s and all values in between, e.g., 50 cm/s.

In one aspect, the uncoated conductor may be drawn through a collection of operational zones that include a pre-heating zone and a flame spraying zone.

The pre-heating zone heats the surface of the uncoated conductor to a temperature of about 200° C. to about 500° C., and all values in between, including about 225° C., about 250° C., about 275° C., about 300° C., about 325°, about 350° C., about 375° C., about 400° C., about 425° C., about 450° C., and about 475° C. In one aspect, the pre-heating zone heats the uncoated conductor to a temperature of about 250° C. to about 350° C., and all values in between, e.g., about 300° C. One may appreciate that any suitable method may be used for pre-heating the uncoated conductor, e.g., a heating oven, UV, IR, E-beam, open flame, or a combination thereof.

The uncoated conductor may be drawn through the pre-heating zone at a rate of about 10 cm/s to about 100 cm/s and all values in between, including, for example, about 20 cm/s, about 25 cm/s, about 30 cm/s, about 35 cm/s, about 40 cm/s, about 45 cm/s, about 50 cm/s, about 55 cm/s, about 60 cm/s, about 65 cm/s, about 70 cm/s, about 75 cm/s, about 80 cm/s, about 85 cm/s, about 90 cm/s, and about 95 cm/s. In one aspect, the uncoated conductor may be drawn through the pre-heating zone at a rate of about 40 cm/s to about 60 cm/s and all values in between, e.g., 50 cm/s.

The pre-heated, uncoated conductor may be drawn through a thermal deposition zone capable of depositing by thermally spraying the ceramic, the filler, the aluminum, or a combination thereof on the pre-heated, uncoated conductor to obtain the coated conductor.

In one aspect, the coating may be deposited by thermal spraying by a suitable method that includes, but is not limited to, powder/wire flame spray, arc spraying, plasma spraying, high velocity oxy fuel (HVOF), high velocity flame spray (HVFS), high velocity air fuel (HVAF), detonation flame (D-gun), cold spray, and the like. See e.g., Vuoristo at 237. As related to a cold spray process, one will appreciate that the thermal energy may be obtained from kinetic energy, and thus, the temperature of the heat source in the cold spray process ranges from about 200° C. to about 1000° C., which may be below some of the materials disclosed herein. However, a cold spray process may be applicable with a mixture of, e.g., aluminum and a ceramic.

In one aspect of the process for preparing a coated overhead aluminum conductor, the coating may be deposited by oxy-acetylene flame spraying. A suitable oxy-acetylene flame spraying system is commercially available from Castolin Eutectic CastoDyn DS8000 Oxy-Acetylene Powder Flame-spray torch. The torch operates on an external combustion process, with the flame occurring externally from the torch. The CastoDyn® 8000 system operates under a deposition rate of about 1 kg/h to about 8 kg/h, with an oxygen flow rate of about 500 Nl/h to about 2000 Nl/h (oxygen pressure of about 4 bar), an acetylene flow rate of about 400 Nl/h to about 800 Nl/h (acetylene pressure of about 0.7 bar), and optionally a compressed air pressure of about 0 to about 6 bar. The gases are injected at the rear, mixed at the mixing nozzle, and then ignited. The powder feedstock (e.g., the ceramic, the filler, the aluminum, or a combination thereof) is carried in the oxygen (via a Venturi effect) before entering the flame. The high temperature of the flame (e.g., about 3000° C. to about 3500° C.) melts (partially or completely) the powder particles while accelerating them, to form a coating on the substrate (e.g., uncoated conductor), providing the coating on the surface.

It will be understood that one may utilize an alternative oxy-acetylene powder flame spray torch that permits variation of the oxygen-to-acetylene ratio (“OAR”). It also will be understood that the flame temperature varies as the OAR varies. For instance, an OAR of about 0.8 to about 1.0 provides a flame temperature of about 3065° C. to about 3100° C., an OAR of about 1 provides a flame temperature of about 3100° C.; and an OAR of about 1.5 to about 2.5 provides a flame temperature of about 3315° C. to about 3430° C. As related to black titania, which differs from titania by having a reduced oxygen content (see, e.g., Glezakou), one may be interested to maintain the OAR of 1 or lower, as an OAR of 1 results in a neutral flame, while an OAR less than 1 results in a carburizing flame. An OAR greater than 1 results in an oxidizing flame, which may introduce oxygen into the black titania. In one aspect, the OAR may be about 1. In another aspect, the OAR may be about 0.8 to less than about 1, and in another aspect, the OAR may be greater than about 1 and less than or equal to about 2.5.

As explained above, CuO may undergo reduction with an OAR of less than 1. Accordingly, it may be of interest to utilize a non-reducing (or oxidizing) flame having an OAR of not less than 1 or a non-reducing flame method so that CuO may not be reduced during the deposition process. The same may be true for other oxides, e.g., spinel(s), alumina oxide, and the like.

In one aspect of the process of the second embodiment, the coated overhead conductor may be obtained by a process comprising: (i) providing an uncoated conductor; (ii) heating the surface of the uncoated conductor to a temperature of from about 200° C. to about 500° C. to obtain a pre-heated, uncoated conductor; (iii) depositing by oxy-acetylene flame spraying the ceramic, the filler, the aluminum, or a combination thereof on the pre-heated, uncoated conductor to obtain the coated conductor; and (iv) optionally applying a hydrophobe or a hydrophobe precursor to the coated conductor.

One may appreciate that a torch that generates the oxy-acetylene flame may be positioned a certain distance from the pre-heated, uncoated conductor. In one aspect, the torch-to-conductor distance ranges from about 10 cm to about 30 cm and all values in between, including, for example, about 10 cm, about 11 cm, about 12 cm, about 13 cm, about 14 cm, about 15 cm, about 16 cm, about 17 cm, about 18 cm, about 19 cm, about 20 cm, about 21 cm, about 22 cm, about 23 cm, about 24 cm, about 25 cm, about 26 cm, about 27 cm, about 28 cm, and about 29 cm. For instance, the torch-to-conductor distance ranges from about 15 cm to about 25 cm, including, for example, about 20 cm.

One may appreciate that an angle generated between a line that extends from the nozzle and the surface of the conductor and the conductor surface may be about 60° to about 120°, including all values in between, such as, for example, about 70°, about 80°, about 90°, about 100°, and about 110°. For instance, the angle generated between a line that extends from the nozzle and the surface of the conductor and the conductor surface may be about 80° to about 100°, including, for example, about 90°.

The oxy-acetylene flame spraying system may comprise at least one powder feedstock hopper. The oxy-acetylene flame spraying system comprises an oxygen gas source, an acetylene gas source, and optionally a carrier gas (e.g., dry air, nitrogen, helium, argon, hydrogen, or a combination thereof), where the powder feedstock (e.g., the ceramic, the filler, the aluminum, or a combination thereof) may be carried in the oxygen (via a venturi effect) before entering the flame. The gases are injected at the rear, mixed at the mixing nozzle, and then ignited. The at least one powder feedstock hopper may deliver the powder feedstock to the flame via the venturi effect. Powder feeding/supply of the powder (e.g., black titania) may be achieved by using a gravity feeding system, whereby a suitably sized hopper is placed on top of the oxy-acetylene flame spray torch. The suction of gas beneath (oxygen or air) may be utilized to promote consistent powder feeding, via a Venturi effect. The feed rate could be changed by opening or closing the orifice size, within 6 pre-set sizes available.

Alternately, the oxy-acetylene flame spraying system may delivery the powder feedstock to the flame via the venturi effect with the assistance of a controller system comprising a motor.

Several controller systems are available commercially, including, for example a commercially available CastoDyn EP controller.

Several powder feedstock hoppers are available commercially, including, for example, an EP2 powder feeder or an EP3 powder feeder. The EP2 powder feeder comprises a powder feeder wheel (e.g., 400118 (one row of cavities) and 260582 (two rows of cavities)). The EP2 powder feeder has the capacity to deliver up to 7 kg/h of nickel-based powder without tungsten carbide and up to 10 kg/hr of nickel-based powder with tungsten carbide. The EP3 powder feeder has the capacity to deliver up to 21.5 kg/h of nickel-based powder and up to 30 kg/h of tungsten carbide. In essence, the different powder feeders may be selected depending on the powder feed rate where the EP2 powder feeder providing a lower feed rate compared to the EP3 powder feeder. One will appreciate that the powder feed rate may be modified by modifying the powder feeder wheel, the powder carrier gas flow rate (e.g., about 3 L/min to about 15 L/min), etc. One also will appreciate that the powder feed rate may depart from the stated nickel-based powder values. The powder feeders (e.g., EP2 or EP3) may be configured with one or more motors and one or more hoppers, e.g., EP2-1M/1 (one motor/one hopper), EP2-1M/2 (one motor/two hoppers), EP2-2M/2 (two motors/two hoppers), EP3-1M/1 (one motor/one hopper), EP3-1M/2 (one motor/two hoppers), and EP3-2M/2 (two motors/two hoppers).

For instance, powder feeder EP3-1M/1 comprises 1 powder box, 1 motor, and a proximity switch for low powder and provides feed rates ranging from about 21.5 kg/h to about 30 kg/h.

Powder Feeder EP3-1M/2 has two powder reservoirs which are operated from one motor. In comparison to the EP3-1M/1 feeder, it is possible to achieve a two-fold feeding capacity. Alternatively, it is possible to use the EP3-1M/2 with 2 different powders. EP3-1M/2 provides feed rates ranging from about 43 kg/h to about 60 kg/h. Powder feeder EP3-2M/2 has two powder reservoirs operated from a separate motor thereby enables to adjust different feeding speeds.

The flame spraying zone may comprise two to ten oxy-acetylene flame spraying systems that may be arranged at varying radial positions with respect to the conductor. For instance, a flame spraying zone may comprise six oxy-acetylene flame spraying systems arranged about 60° around the conductor as it passes through the flame spraying zone. Development work shows that a radial flame offset may be about 15 mm, thus, the number of torches may depend on the diameter (D)/circumference (C) of the conductor. The following table illustrates the number of torches utilized for variously sized conductors using a radial offset of about 15 mm.

| D | C | | | |
|---|---|---|---|---|
| (mm) | (mm) | C/15* | N | 360°/N |
| 5 | 16 | 1.0 | 2 | 180° |
| 7 | 22 | 1.5 | 2 | 180° |
| 9 | 28 | 1.9 | 2 | 180° |
| 11 | 35 | 2.3 | 2-3 | 180°/120° |
| 13 | 41 | 2.7 | 3 | 120° |
| 15 | 47 | 3.1 | 3 | 120° |
| 17 | 53 | 3.6 | 3-4 | 120°/90° |
| 19 | 60 | 4.0 | 4 | 90° |
| 21 | 66 | 4.4 | 4-5 | 90°/72° |
| 23 | 72 | 4.8 | 4-5 | 90°/72° |
| 25 | 79 | 5.2 | 5 | 72° |
| 27 | 85 | 5.7 | 6 | 60° |
| 29 | 91 | 6.1 | 6 | 60° |
| 31 | 97 | 6.5 | 6-7 | 60°/51° |
| 33 | 104 | 6.9 | 7 | 51° |
| 35 | 110 | 7.3 | 7-8 | 51º/45° |
| 37 | 116 | 7.7 | 8 | 45° |
| 39 | 123 | 8.2 | 8-9 | 45º/40° |
| 41 | 129 | 8.6 | 9 | 40° |
| 43 | 135 | 9.0 | 9 | 40° |
| 45 | 141 | 9.4 | 9-10 | 40°/36° |

Abbreviations: Conductor diameter (D), Conductor circumference (C), Circumference divided by radial offset of about 15 mm (C/15), Number of torches (N), and Radial positions of torches (360°/N).

Thus, a conductor (e.g., 795/ACSS/TW/DRAKE) having a diameter of about 25 mm and a circumference of about 79 mm, the number of torches may be 5. Further, a conductor (e.g., 795/HS285/26/7/DRAKE or 795/ACSS/45-7/TERN) having a diameter of about 27 mm and a circumference of about 85 mm, the number of torches may be 6.

In one aspect of the process of the second embodiment, the coated overhead conductor may be obtained by a process comprising: (i) providing an uncoated conductor; (ii) heating the surface of the uncoated conductor to a temperature of from about 200° C. to about 500° C. to obtain a pre-heated, uncoated conductor; (iii) depositing by oxy-acetylene flame spraying the ceramic, the filler, the aluminum, or a combination thereof on the pre-heated, uncoated conductor to obtain the coated conductor; and (iv) optionally applying a hydrophobe or a hydrophobe precursor to the coated conductor; wherein the flame spraying comprises two to ten oxy-acetylene flame spraying systems, for example, six or seven oxy-acetylene flame spraying systems.

The oxy-acetylene flame spraying systems may be arranged so that deposition occurs at the same time. In certain instances, it may be of interest to separate the oxy-acetylene flame spraying systems by a distance that permits partial cooling of the conductor as it passes through the flame spraying zone. For instance, six oxy-acetylene flame spraying systems may be separated by a distance of from about 0 cm to about 100 cm and all values in between, including, for example, about 10 cm, 20, 30, 40, 50, 60, 70, 80, and 90 cm, and be configured to coat the conductor at different radial zones. One will appreciate that the distance may depend on the pre-heating conditions. For instance, surface heating (fast heating, e.g., with use of flame, limited to outer wires) may result in relatively rapid cooling (e.g., about 100° C. in couple of seconds) because of combined effect of convection and conduction. In this case, torches may be relatively close to each other to avoid temperature drop below recommended pre-heating temperature. Alternatively, heating of inner and outer wires (e.g., oven heating) may result in relatively slow cooling (e.g., about 100° C. per minute) because cooling may be limited to convection. In this case, torches may be situated at a great distance from one other.

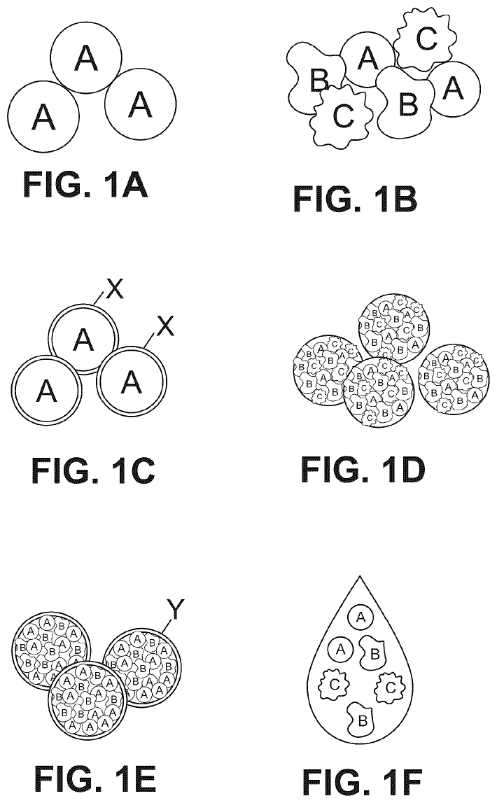

With reference to FIG. 1, one will appreciate that a feedstock material used for the coating may be uncoated or the feedstock material may comprise a secondary coating layer, e.g., an overlayer (e.g., a ceramic overlayer or a hydrophobe overlayer). In that regard, FIG. 1 contemplates several alternatives for the feedstock material that may comprise a ceramic, a filler, an aluminum, or a combination thereof. For instance, the coating may be derived from a powder material that includes (a) micrometer sized particles (FIG. 1(A)); (b) a mixture of micrometer sized particles (FIG. 1(B)); (c) micrometer sized coated-particles (FIG. 1(C); (d) micrometer-sized particles comprised of agglomerated a nanometer-sized particle, a sub-micron sized particle, or a combination thereof (FIG. 1(D)); (e) coated micrometer-sized particles comprised of agglomerated a nanometer-sized particle, a sub-micron sized particle, or a combination thereof (FIG. 1(E)); and (f) nanometer-sized particles and/or sub-micron sized particles suspended in a liquid carrier (FIG. 1(F)) (viz., “suspension thermal spray”). The secondary coatings (e.g., FIG. 1(C), “X” or FIG. 1(E) “Y”)) may include, for example, a metal- or carbon-based coating over a ceramic (e.g., black titania or alumina), including, for example a graphene-coated alumina. As related to the “suspension thermal spray,” contemplated in FIG. 1(F), one may appreciate that a coating comprising a rare earth compound (e.g., CeO2) may be obtained using a plasma or an HVOF process.

The feedstock material may comprise a first ceramic having a micron particle size, a submicron particle size, a nanometer particle size, or a combination thereof; the feedstock material may further comprise the second ceramic, the filler, the aluminum, or a combination thereof and may have a micron particle size, a submicron particle size, a nanometer particle size, or a combination thereof.

For illustrative purposes, the feedstock material may comprise a first ceramic, a second ceramic, a filler, an aluminum, or a combination thereof, where the feedstock material has an average particle size of about 10 μm to about 100 μm, and all values in between, including, for example, about 15 μm, about 20 μm, about 25 μm, about 30 μm, about 35 μm, about 40 μm, about 45 μm, about 50 μm, about 60 μm, about 65 μm, about 70 μm, about 75 μm, about 80 μm, about 85 μm, about 90 μm, and about 95 μm. Further, the feedstock material may have an average particle size having submicron and/or nanometer sizes, which may form an agglomerated particle having an average particle size of about 10 μm to about 100 μm, and all values in between, including, for example, about 20 μm, about 30 μm, about 40 μm, about 50 μm, about 60 μm, about 70 μm, about 80 μm, and about 90 μm.

A hydrophobic-coated overhead conductor may be obtained by applying a hydrophobe or a hydrophobe precursor to the coated conductor. In one aspect, the hydrophobe or hydrophobe precursor may be applied once the temperature of the coated conductor is about (or less) the boiling point temperature of carrier solvent used for the hydrophobe or hydrophobe precursor. For instance, if the carrier solvent comprises water (boiling point (“BP”) of about 100° C.), then the hydrophobe or hydrophobe precursor may be applied when the temperature of the coated conductor is about 100° C. or lower. One may appreciate that carrier solvents may differ for various hydrophobes or hydrophobe precursors (e.g., Nasiol-Z (ethanol, BP of about 78° C.), Synasylan 8263 or FAS (isopropanol, BP of about 82° C.). One may appreciate that the hydrophobe or hydrophobe precursor may be applied once the coated conductor achieves a temperature close to ambient temperature. Alternatively, the hydrophobe or hydrophobe precursor may be applied at some later time, e.g., at the time of installation.

The uncoated, aluminum conductor may be mill-finished or it may be pre-treated by grit-blasting.

An aspect of the process of the second embodiment may further comprise grit-blasting the uncoated conductor using a suitable abrasive media.

Grit-blasting may be achieved by any suitable method. Abrasive media used for grit-blasting may include, for example, black volcanic basalt grit, brown aluminum oxide, white aluminum oxide, garnet, obsidian glass, corundum, silicon carbide, and the like, but not silica (i.e. sand), as silica-blasting may generate fines (e.g., respirable crystalline silica) that may be inhaled by an operator and cause silicosis. Abrasive media selected for surface treatment prior to thermal spraying included, e.g., grade 25 black volcanic basalt grit (100-700 μm), grade 40 brown aluminum oxide (100-420 μm), grade 60 white aluminum oxide (50-250 μm), and grade 120 white aluminum oxide (50-125 μm).

In one aspect, the process of the second embodiment comprises: (i) providing an uncoated conductor; (ii) grit blasting the uncoated conductor to obtain a grit-blasted, uncoated conductor (iii) heating the surface of the grit-blasted, uncoated conductor to a temperature of from about 200° C. to about 500° C. to obtain a pre-heated, grit-blasted, uncoated conductor; (iv) depositing by thermally spraying the ceramic, the filler, the aluminum, or a combination thereof on the pre-heated, grit-blasted, uncoated conductor to obtain the coated conductor; and (v) optionally applying a hydrophobe or a hydrophobe precursor to the coated conductor.

One also will appreciate that the coating may comprise a degree of porosity where a void space may exist within the continuum of overlaid splats. A void space may provide for egress of a corrosive liquid (e.g., water, acidified water, salty water, etc.) that may result in corrosion of the conductor and/or coating. Accordingly, it may be of interest to apply a hydrophobe or a hydrophobe precursor to the coated conductor.

In one aspect of the process of the second embodiment, said process comprises: (i) providing an uncoated conductor; (ii) heating the surface of the uncoated conductor to a temperature of from about 200° C. to about 500° C. to obtain a pre-heated, uncoated conductor; (iii) depositing by thermally spraying the ceramic, the filler, the aluminum, or a combination thereof on the pre-heated, uncoated conductor to obtain the coated conductor; and (iv) applying a hydrophobe or a hydrophobe precursor to the coated conductor to obtain a hydrophobic-coated conductor.

A hydrophobe or hydrophobe precursor may be obtained from a hydrocarbon, an oil, an alkyl silane, a silane, or a combination thereof. Sec, e.g., Arkles, Heiman-Burstein, and Polizos. For instance, a hydrophobe or hydrophobe precursor may be obtained from a polydimethylsiloxane (“PDMS”); HDTMS (hexadecyltrimethoxysilane ≥85%, CAS No. 16415-12-6); MTMS (trimethoxymethylsilane 98%, CAS No. 1185-55-3); TEOS (tetraethyl orthosilicate 98%, CAS No. 78-10-4); MTES (triethoxymethylsilane ≥97.0%, CAS No. 2031-67-6); DMDCS (dichlorodimethylsilane ≥98.5%, CAS No. 75-78-5); GLYMO (3-glycidyloxypropyl)-trimethoxysilane, CAS No. 2530-83-8); VTMO (trimethoxyvinylsilane, CAS No. 2768 Feb. 7); Dynasylan 1146 (trimethoxy (propyl) silane (“TMETPS”), CAS No. 1067-25-0); APTMS ((3-aminopropyl)-trimethoxysilane, CAS No. 13822-56-5); APTES (3-Aminopropyl) triethoxysilane, CAS No. 919-30-2); i Dynasylan SIVO 160 (a hydrolysable silane, CAS No. 1443627-61-9); Dynasylan 8263 (1H,1H,2H,2H-perfluorooctyl-triethoxysilane (“FAS,” CAS No. 51851-37-7); Nasiol-Z (ethanol-based formulation); Nasiol-Z-WB (water-based formulation); or a combination thereof. Nasiol-Z and Nasiol-Z-WB hydrophobe precursors are commercially available from Artekya Ltd. Co., of Istanbul, Turkey, and may be considered to be sol-gel hydrophobe precursors.

Applying a hydrophobe or a hydrophobe precursor may be achieved by any suitable method that provides for a coated conductor having a contact angle of about 90° or higher or a slide angle of about 10° or lower.

In one aspect, a hydrophobe may be applied to the coated conductor to obtain a hydrophobic-coated conductor.

In one aspect, a hydrophobe precursor may be applied to the coated conductor.

In another aspect, the hydrophobe precursor may be contacted with water to obtain a hydrolyzed hydrophobe precursor, where the hydrolyzed hydrophobe precursor is then applied to the coated conductor to obtain a hydrophobic-coated conductor. In one aspect, the hydrophobe precursor may be any suitable silane capable of silanization of the coating described herein. Examples of hydrophobe precursors, include, but are not limited to HDTMS, MTMS, MTES DMDCS, GLYMO, VTMO, TMETPS, APTMS, APTES, FAS, and the like, including for example a commercially available hydrolysable silane, including for example, Dynasylan 1146.

In yet another aspect, the hydrophobe precursor (e.g., HDTMS) may be contacted with a suitable alkoxysilane (e.g., tetraethoxysilane (aka tetraethyl orthosilicate or TEOS)) in the presence of a suitable alcoholic aqueous solution to obtain a hydrophobe sol-gel. A suitable alcohol may include methanol, ethanol, isopropanol and the like. The aqueous solution comprises water and optionally an acid (e.g., nitric acid) or a base (e.g., ammonium hydroxide). Known methods may be utilized for obtaining the hydrophobe sol-gel. Sec, e.g, Heiman-Burstein. Sample experiments showed that one may obtain a hydrophobe sol-gel by contacting TEOS (about 5.3% v/v), HDTMS (about 5.3% v/v), an ammonium hydroxide solution (3 mL of a 25% solution of ammonium hydroxide), and 50 mL isopropanol. The hydrophobe sol-gel may be used immediately after mixing, or the hydrophobe sol-gel may be used after an extended time after mixing of from about 2 to about 24 hours to permit polymerization. The hydrophobe sol-gel was contacted with a coated (e.g., black titania) conductor (aluminum) and dried under various conditions (e.g., air dried or oven dried (e.g., about 120° C. for about 15 minutes)). Results showed the preparation of a hydrophobic-coated conductor having a contact angle of at least 90° or more and that with an increase in the amount of PDMS/SiO₂ (e.g., 100 mg/mL, 200 mg/mL, 500 mg/mL (in 5 mL of hydrolyzed HDTMS), etc.) one may achieve a slide angle of less than about 10°.

In yet another aspect, the hydrophobe precursor (e.g., HDTMS) may be contacted with water and a modified fumed silica, where the modified fumed silica may be obtained by contacting a siloxane (e.g., polydimethylsiloxane (or PDMS)) with fumed silica to obtain a PDMS-modified fumed silica (PDMS/SiO₂). Sample experiments showed that one may achieve a hydrophobic coating by using a fixed volume of a hydrolyzed hydrophobe precursor and a varying amount of PMDS/SiO₂ (e.g., 0.1 g of PDMS/SiO₂ to milliliter of hydrolyzed hydrophobe precursor, 0.2 g of PDMS/SiO₂ to milliliter of hydrolyzed hydrophobe precursor, and 0.5 g of PDMS/SiO₂ to milliliter of hydrolyzed hydrophobe precursor). Sample experiments show that application of a composition comprising PDMS/SiO₂ and a hydrolyzed hydrophobe precursor results in a hydrophobe, coated conductor having a contact angle of at least 90° or more and that with an increase in the amount of PDMS/SiO₂ one may achieve a slide angle of less than about 10°.

In yet another aspect, the hydrophobe precursor (e.g., PDMS/SiO₂) may be contacted with a cellulosic binder (e.g., ethyl cellulose (EC)) (e.g., 300 cps grade EC) in an alcoholic solvent (e.g., isopropanol). The weight ratio of a cellulosic binder to hydrophobe (e.g., EC-to-PDMS/SiO₂) may vary from about 90:10, about 80:20, about 70:30, about 60:40, about 50:50, about 40:60, about 30:70, about 20:80, and about 10:90.

In one aspect of the process of the second embodiment, said process comprises: (i) providing an uncoated conductor; (ii) heating the surface of the uncoated conductor to a temperature of from about 200° C. to about 500° C. to obtain a pre-heated, uncoated conductor; (iii) depositing by thermally spraying the ceramic, the filler, the aluminum, or a combination thereof on the pre-heated, uncoated conductor to obtain the coated conductor; (iv) applying a hydrophobe or a hydrophobe precursor to the coated conductor to obtain a hydrophobic-coated conductor.

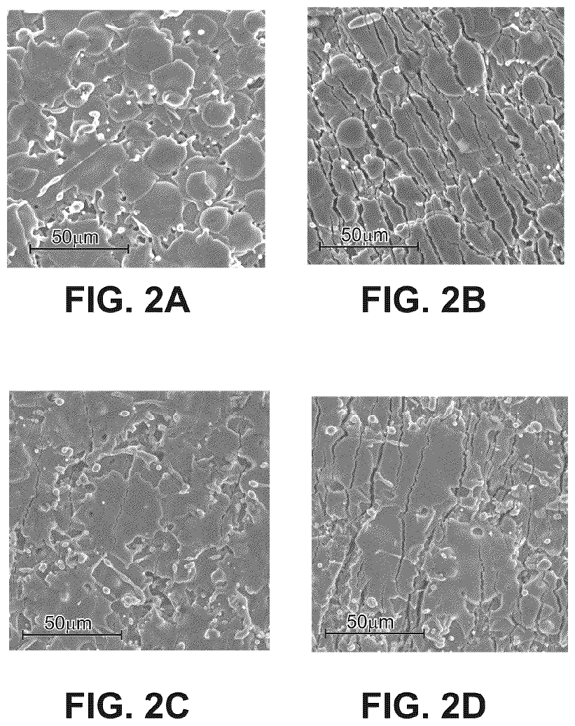

As the high temperature of a thermal spray method may melt the powder (e.g., black titania) particles, the powder particle material liquifies (totally or partially) providing molten particles (or molten droplets) comprising liquified material, solid material, or a combination thereof. The molten particles impact the solid substrate (e.g., the conductor) and flatten upon impact forming splattered droplets (or splats) which form the coating. As the splattered droplets accumulate on the surface of the substrate (e.g., the conductor), a layering effect may occur, creating a continuum of overlaid splats. The thickness of the coating may depend on numerous factors, including, for example, the feedstock material particle size, the exposure time of the substrate (e.g., the conductor) with the molten particles, the flame/gas velocity, and the like. One will appreciate that the coating may comprise a splat, an unmelted particle, a partially melted particle/resolidified particle, an oxide region, and the like. The coating layer may result from the liquified droplets contacting the conductor surface, where numerous liquified droplets splatter (regularly or irregularly) on the conductor surface. As the melting point (“Tmp”) of aluminum is about 660° C., contact of the liquified droplets (e.g., black titania) may result in partial liquification of the surface aluminum. The contact between the liquified droplets (e.g., black titania) and the surface aluminum may result in an interfacial weld between the coating (e.g., black titania) and the aluminum. Conceptually, a similar interfacial weld would occur for an aluminum-alloy (e.g., Grade 6082 (Tmp about 555° C.), 6082-T6, 1350, and the like) or an aluminum-zirconium alloy containing aluminum (e.g., 1350-H19 aluminum) and from about 0.2 to about 0.33% by weight of zirconium. With reference to FIG. 2, SEM analysis showed the microstructure and morphology of the coatings produced using two grades of black titania powder (viz., FIG. 2A (#1000) and FIG. 2C (#1001) on the conductor substrate). The SEM analysis revealed droplet splatter (or splats) of the smaller powder were approximately half the size of the larger powder.

The coated overhead aluminum conductor has a coating thickness of about 10 μm to about 50 μm, and all values in between, such as about 15 μm, about 20 μm, about 25 μm, about 30 μm, about 35 μm, about 40 μm, and about 45 μm. And the coating may range from about 5 μm to about 30 μm, from about 10 μm to about 20 μm, from about 10 μm to about 60 μm or the coating may have a thickness of about 20 μm to about 50 μm.

### Third Embodiment: Coated Overhead Aluminum Conductor Prepared by Process of the Second Embodiment

A third embodiment relates to coated overhead conductor of the first embodiment including aspects thereof prepared according to the process a process of the second embodiment and aspects thereof.

Yet another aspect relates to a coated overhead aluminum conductor, prepared by a process, which comprises: (i) providing an uncoated conductor; (ii) heating the surface of the uncoated conductor to a temperature of from about 200° C. to about 500° C. to obtain a pre-heated, uncoated conductor; (iii) depositing by thermally spraying the ceramic, the filler, the aluminum, or a combination thereof on the pre-heated, uncoated conductor to obtain the coated conductor; and (iv) optionally applying a hydrophobe or a hydrophobe precursor to the coated conductor.

Yet another aspect relates to a hydrophobic-coated overhead aluminum conductor, prepared by a process, which comprises: (i) providing an uncoated conductor; (ii) heating the surface of the uncoated conductor to a temperature of from about 200° C. to about 500° C. to obtain a pre-heated, uncoated conductor; (iii) depositing by thermally spraying the ceramic, the filler, the aluminum, or a combination thereof on the pre-heated, uncoated conductor to obtain the coated conductor; and (iv) applying a hydrophobe or a hydrophobe precursor to the coated conductor to obtain a hydrophobic-coated conductor.

Each of the aspects disclosed for the first and second embodiments may be applicable to the third embodiment

### Examples

The following exemplified embodiments illustrate aspects of the coated overhead conductor and the hydrophobic-coated overhead conductor disclosed herein and should not be considered to be limiting on the subject matter claimed herein.

Assessing the coatings was achieved by visual inspection, followed by bend testing around a mandrel. FIG. 2 depicts SEM images of the microstructure and morphology of the coatings produced using two grades of black titania powder (viz., FIG. 2A (#1000) and FIG. 2C (#1001) on the conductor substrate). To determine the adhesion acceptability, samples were bent around two mandrels: a 25 mm diameter size and a 12.7 mm diameter size. The mandrel approach tested both the coating cohesion and adhesion. Coating cohesion relates generally to the ability of the coating to remain internal bonding, while coating adhesion relates generally to the ability of the coating to adhere to the conductor. Minor cracking was deemed permissible (see FIG. 2B (#1000) and FIG. 2D (#1001)), otherwise any worse was considered to be a failure. Again, one or more microcracks may be beneficial because of mismatch in coefficient of thermal expansion between aluminum conductor and coating (e.g., ceramic).

Coating thickness may be measured using ElektroPhysik MiniTest 745 with FN 1.5 probe).

Current carrying capacity (ampacity) tests were performed using setup comprising 3200 W DC power supply, Keysight N8731A, sourcing up to 400A and Pico TC-08 thermocouple data loggers. All measurement were carried using 120 cm long aluminum (grade 6082) samples, 12.7 mm×3.2 mm (½″×⅛″). Distance between terminals was 100 cm while temperature was recorded using 5 evenly spaced thermocouples placed directly on the conductor (where coating was removed by a high-speed burr). Samples were subjected to current of 0 A, 200A, and 300A with and without exposure to light generated by four halogen lamps, 120 W each. Temperature measurements were recorded for 30 minutes and the last 10-minutes of temperature data were collected and averaged-representing a steady-state temperature measurement.

The following table summarizes ampacity testing of coated conductors that evaluated the observed temperatures (T^{obs}, ° C., with standard deviation (SD)) of the central thermocouple for coated conductors in the presence (T_{light}^{obs}) and absence (T_{dark}^{obs}) of light, where the sample is comprised of (1) aluminum conductor (no coating), (2) aluminum conductor coated with black titania (“BT”), (3) aluminum conductor coated with BT and spinel (“SP”) in a weight ratio of 1-to-1, (4) aluminum conductor coated with BT and SP in a weight ratio of 1-to-10, (5) aluminum conductor coated with BT and cupric oxide (“CuO”) in a weight ratio of 10-to-1, (6) aluminum conductor coated with BT and CuO in a weight ratio of 5-to-1, and (7) aluminum conductor coated with BT and CuO in a weight ratio of 2.5-to-1.

| | | T_{light}^{obs}(° C.) (SD) | | | T_{dark}^{obs}(° C.) (SD) | | |
|---|---|---|---|---|---|---|---|
| No. | Sample^{†} | 0A | 200A | 300A | 0A | 200A | 300A |
| 1 | MF AL | 25.7 | 126.2 | 308.4 | 16.6 | 112.4 | 281.1 |
| | | (0.20) | (0.90) | (1.36) | (0.05) | (0.62) | (0.44) |
| 2 | BT | 51.1 | 113.9 | 189.34 | 20.7 | 86.0 | 166.8 |
| | | (0.53) | (0.67) | (0.45) | (0.05) | (0.30) | (0.62) |
| 3 | BT + SP (1:1) | 48.5 | 110.6 | 193.5 | 16.1 | 82.9 | 165.4 |
| | | (0.16) | (0.39) | (0.52) | (0.04) | (0.48) | (0.61) |
| 4 | BT + SP | 46.5 | 113.7 | 201.8 | 14.7 | 87.2 | 176.5 |
| | (1:10) | (0.37) | (0.46) | (0.53) | (0.06) | (0.16) | (0.54) |
| 5 | BT + CuO | 50.6 | 112.2 | 190.2 | 14.3 | 81.0 | 163.1 |
| | (10:1) | (0.32) | (0.49) | (0.54) | (0.03) | (0.35) | (0.96) |
| 6 | BT + CuO | 51.6 | 112.1 | 191.8 | 15.3 | 83.2 | 165.1 |
| | (5:1) | (0.25) | (0.39) | (0.68) | (0.14) | (0.45) | (0.72) |
| 7 | BT + CuO | 48.0 | 118.4 | 200.6 | 15.6 | 81.7 | 165.2 |
| | (2.5:1) | (0.29) | (0.47) | (0.47) | (0.04) | (0.22) | (0.55) |

^{†}Abbreviations: SD (standard deviation), MF Al (mill-finished aluminum conductor), BT (black titania coated conductor), BT + SP (1:1) (black titania and spinel coated conductor with a weight ratio of 1-to-1), BT + SP (1:10) (black titania and spinel coated conductor with a weight ratio of 1-to-10), BT + CuO (10:1) (black titania and cupric oxide coated conductor with a weight ratio of 10-to-1), BT + CuO (5:1) (black titania and cupric oxide coated conductor with a weight ratio of 5-to-1), BT + CuO (2.5:1) (black titania and cupric oxide coated conductor with a weight ratio of 2.5-to-1).

With respect to the samples exposed to light, it may be seen that the temperature of a coated conductor (200 A) was reduced by about 10% to about 25% relative to an aluminum conductor with no coating, while the temperature of a coated conductor (300 A) was reduced by about 35% to about 45% relative to an aluminum conductor with no coating. For instance, it may be seen that an applied current of 200 A resulted in, for example, ΔT_{light}^{obs} (Sample No. 2-Sample No. 1) of −12.3±1.1° C. (≈10% temperature reduction), while an applied current of 300 A resulted in, for example, ΔT_{light}^{obs} (Sample No. 2-Sample No. 1) of −119.1±1.4° C. (˜ 39% temperature reduction).

With respect to the samples exposed to no light, it may be seen that the temperature of a coated conductor (200 A) was reduced by about 25% to about 35% relative to an aluminum conductor with no coating, while the temperature of a coated conductor (300 A) was reduced by about 35% to about 45% relative to an aluminum conductor with no coating.

Exemplary coated (black titania) overhead cables (e.g., 795/ACSS/TW/DRAKE, 795/ACSS/45-7/TERN, 795/ACSS/HS285/26-7/DRAKE) were prepared using oxy-acetylene flame spraying, with a coating thickness of about 5 μm to about 30 μm. Further, exemplary hydrophobic-coated (black titania) overhead cables (e.g., 795/ACSS/TW/DRAKE and 795/ACSS/45-7/TERN) were prepared using oxy-acetylene flame spraying, with a coating thickness of about 5 μm to about 30 μm, and coated using a hydrophobe (e.g., a water-based formulation of Nasiol Z).

Coated conductors were analyzed by SEM using a Jeol-6610-LV operating at 10 kV under a vacuum of about 30 Pa. Elemental analysis of the coated conductors was conducted by EDX using an Oxford X-Max 80° detector with X-ray counts of about 5,000 counts per second. EDX analysis of the coating layer of a coated overhead conductor (e.g., ACSS/TW/Drake) showed that the coating layer includes about 22% w/w of aluminum in the coating layer based on the total weight of the coating layer. This data supports the concept that an interfacial weld exists between the coating layer and the conductor.

### Disclosed Aspects

Aspect 1. A coated overhead conductor comprising: a conductor comprising aluminum or an alloy thereof and a coating comprising (a) a ceramic or a ceramic and a filler, and (b) optionally a hydrophobe.

Aspect 2. The coated overhead conductor of Aspect 1, wherein the conductor comprises an ACSS, an ACCS, a ZTACCR, or a ZTACSR.

Aspect 3. The coated overhead conductor of any one of the preceding Aspects, wherein the ceramic comprises alumina, mullite, spinel, black titania, cupric oxide, or a combination thereof.

Aspect 4. The coated overhead conductor of any one of the preceding Aspects, wherein the filler comprises a rare earth metal compound, a graphite, a graphene, a carbon nanotube, a hexagonal boron nitride, lamp black, carbon black, cupric oxide (CuO), an iron (II) oxide, an iron (III) oxide, an iron (II,III) oxide), white titania (TiO₂), or a combination thereof.

Aspect 5. The coated overhead conductor of any one of the preceding Aspects, wherein the coating further comprises one or more aluminum splats.

Aspect 6. The coated overhead conductor of any one of the preceding Aspects, wherein the coating is deposited on the surface of the conductor by a thermal spray.

Aspect 7. The coated overhead conductor of any one of the preceding Aspects further comprising an interfacial weld between the coating and the conductor.

Aspect 8. The coated overhead conductor of any one of the preceding Aspects further comprising an interfacial weld between the coating and the conductor.

Aspect 9. The coated overhead conductor of any one of the preceding Aspects, wherein the coating has a thickness of about 5 μm to about 100 μm.

Aspect 10. The coated overhead conductor of any one of the preceding Aspects, wherein the coating has a thickness of about 5 μm to about 30 μm.

Aspect 11. A coated overhead conductor comprising: a conductor comprising aluminum or an alloy thereof and a coating comprising (a) a ceramic or a ceramic and a filler;; wherein the ceramic comprises alumina, mullite, spinel, black titania, cupric oxide, or a combination thereof.

Aspect 12. The coated overhead conductor of Aspect 11, wherein the coating further comprises a hydrophobe and wherein a water droplet on the coating has a water contact angle of at least 90° and/or a slide angle of at most about 10°.

Aspect 13. The coated overhead conductor of any one of Aspects 11-12, wherein the conductor comprises an ACSS, an ACCS, a ZTACCR, or a ZTACSR.

Aspect 14. The coated overhead conductor of any one of Aspects 11-13, wherein the ceramic comprises black titania.

Aspect 15. The coated overhead conductor of any one of Aspects 11-14, wherein the filler comprises a rare earth metal compound, a graphite, a graphene, a carbon nanotube, a hexagonal boron nitride, lamp black, carbon black, cupric oxide (CuO), an iron (II) oxide, an iron (III) oxide, an iron (II,III) oxide), white titania (TiO₂), or a combination thereof.

Aspect 16. The coated overhead conductor of any one of Aspects 11-15, wherein the coating further comprises one or more aluminum splats.

Aspect 17. The coated overhead conductor of any one of Aspects 11-16, wherein the coating is deposited on the surface of the conductor by a thermal spray.

Aspect 18. The coated overhead conductor of any one of Aspects 11-17 further comprising an interfacial weld between the coating and the conductor.

Aspect 19. The coated overhead conductor of Aspect 13 further comprising an interfacial weld between the coating and the conductor.

Aspect 20. The coated overhead conductor of any one of Aspects 11-19, wherein the coating has a thickness of about 5 μm to about 100 μm.

Aspect 21. The coated overhead conductor of any one of Aspects 11-12, wherein the coating has a thickness of about 5 μm to about 30 μm.

Aspect 22. The coated overhead conductor of any one of the preceding claims, wherein the conductor has a temperature of from about 10% to about 25% lower than an uncoated conductor each illuminated with light and each bearing a load of 200 A; wherein the conductor has a temperature of from about 25% to about 55% lower than an uncoated conductor each illuminated with no light and each bearing a load of 200 A; wherein the conductor has a temperature of from about 35% to about 45% lower than an uncoated conductor each illuminated with light and each bearing a load of 300 A; and/or wherein the conductor has a temperature of from about 35% to about 45% lower than an uncoated conductor each illuminated with no light and each bearing a load of 300 A.

### CITED INFORMATION

ACSS: Aluminum Conductor, Steel Supported, (2015) (“ACSS Product Information”).
Arkles, B., Tailoring surfaces with silanes, Chemtech (1977) 7 (12): 766-778 (“Arkles”).
Azimi et al., Hydrophobicity of rare-earth oxide ceramics, Nature Materials (2013) 12:315-320 (“Azimi”).
Brugnara, M. ImageJ, (imagej.nih.gov/ij/plugins/contact-angle.html, last accessed on Nov. 7, 2021).
Carbon Black, Kirk-Othmer Encyclopedia of Chemical Technology, (2003) Vol. 4, pp. 761-803 (“Kirk-Othmer”).
Day, J., Thermochromism of Inorganic Compounds, Chemical Reviews (1968) 68 (6): 649-657 (“Day”).
Fauchais et al., From Powders to Thermally Sprayed Coatings, Journal of Thermal Spray Technology (2010) 19 (1-2): 56-80 (“Fauchais”).
French Patent Application Publication No. FR 2 971 617 A1, Improved overhead electric cable, published on Aug. 17, 2012 to Sandrine et al. of Nexans (“Sandrine”).
German Patent No. DE 3 824 608 C1, Method of equipping an overhead-line conductor for a high-voltage overhead line with a black surface layer, published on Aug. 17, 1989 to Sallachner et al. of Berndorf F. A. S Freileitungen und Aluminum Sonderprodukte GmbH (“Sallachner”).
Glezakou et al., Shedding light on black titania, Nature Materials (2018) 17:851-859 (“Glezakou”).
Heiman-Burstein, et al., Hybrid sol-gel superhydrophobic coatings based on alkyl silane-modified nanosilica, Polymers (2021) 13:539, 1-4 (DOI: 10.3390/polym13040539) (“Heiman-Burstein”).
International Publication No. WO 2007/034248 A1, Overhead conductor with spectrally selective surface, published on Mar. 29, 2007 to Simic (“Simic”).
Janczarek et al., Defective Dopant-Free TiO₂ as an Efficient Visible Light-Active Photocatalyst, Catalyts (2021) 11, 978:1-21 (“Janczarek”).
Law, K-Y, Definitions for Hydrophilicity, Hydrophobicity, and Superhydrophobicity: Getting the Basics Right, J. Phys. Chem. Lett. (2014) 5:686-688 (“Law”).
Overhead Conductor Manual, 2nd Edition, 2007 (“OHCM”).
Polizos et al., Scalable superhydrophobic coatings based on fluorinated diatomaceous earth: Abrasion resistance versus particle geometry, Journal Applied Surface Science (2014) 292:563-569 (“Polizos”).
Sankar et al., Hydrophobic and Metallophobic Surfaces: Highly Stable Non-wetting Inorganic Surfaces Based on Lanthanum Phosphate, Nanorods Nature Sci. Reports (2016) 6, 22732, 1-7 (“Sankar”).
Sinhamahapatra et al., A new approach to prepare highly active and stable black titania for visible light-assisted hydrogen production, Energy Environ. Sci. (2015) 8:3539-3544 (“Sinhamahapatra”).
Spinel Supergroup, available at www.mindat.org/min-52865.html, last accessed on Nov. 9, 2021 (“MinDat”).
Stalder, A., LBADSA Plugin (biii.eu/lbadsa, last accessed on Nov. 7, 2021).
Tejero-Martin et al., Beyond Traditional Coating: A review of thermal sprayed functional and smart coatings, Journal of Thermal Spray Technology (2019) 28, 598-644 (“Tejero-Martin”).
Urrea, et al. Effect of Torch Hardware on Oxy-Acetylene Powder Flame Spray Performance, Sandia National Lab, 2005. Web (www.osti.gov/biblio/1465552-effect-torch-hardware-oxy-acetylene-powder-flame-spray-performance, accessed on Nov. 7, 2021) (“Urrea”).
U.S. Pat. No. 9,859,038 B2, Surface modified overhead conductor, issued on Jan. 2, 2018 to Davis et al. of General Cable Technologies Corporation (“Davis”).
U.S. Pat. No. 9,953,747 B2, Electroceramic coating of a wire for use in a bundled power transmission cable, issued on Apr. 24, 2018 to Dolan et al. of Henkel AG & Co. KGaA (“Dolan”).
U.S. Pat. No. 10,332,658 B2, Method of forming a coated overhead conductor, issued on Jun. 25, 2019 to Mhetar et al., of General Cable Technologies Corporation and Emisshield, Inc. (“Mhetar”).
U.S. Pat. No. 10,957,467 B2, Coated overhead conductor, issued on Mar. 23, 2021 to Ranganathan et al., of General Cable Technologies Corporation (“Ranganathan”).
U.S. Patent Application Publication No. 2017/0137659 A1, Cables coated with fluorocopolymer coatings, published on May 18, 2017 to Ranganathan, Siripurapu, et al. of General Cable Technologies Corporation and Arkema Inc. (“Siripurapu”).
Vuorista, P., Thermal Spray Coating Processes, Comprehensive Materials Processing (2014) 4:229-276 (“Vuorista”).
Winnicki, M., Advanced functional metal-ceramic and ceramic coatings deposited by low-pressure cold spraying: A review, Coatings (2021) 11:1044, 1-51 (“Winnicki”).

This application claims priority to U.S. Provisional Patent Application No. 63/286,852, filed on 7 Dec. 2021, the disclosure of which is hereby incorporated by reference herein in its entirety along with the subject matter of all information cited herein. If there is a difference between the meaning of subject matter incorporated by reference and the meaning of subject matter disclosed herein, the meaning of the subject matter disclosed herein will control.

1. A coated overhead conductor comprising: a conductor comprising aluminum or an alloy thereof and a coating comprising (a) a ceramic or a ceramic and a filler; and (b) optionally a hydrophobe.

2. The coated overhead conductor of claim 1, wherein the conductor comprises an ACSS, an ACCS, a ZTACCR, or a ZTACSR.

3. The coated overhead conductor of claim 1, wherein the ceramic comprises alumina, mullite, spinel, black titania, cupric oxide, or a combination thereof.

4. The coated overhead conductor of claim 1, wherein the filler comprises a rare earth metal compound, a graphite, a graphene, a carbon nanotube, a hexagonal boron nitride, lamp black, carbon black, cupric oxide (CuO), an iron (II) oxide, an iron (III) oxide, an iron (II,III) oxide, white titania (TiO₂), or a combination thereof.

5. The coated overhead conductor of claim 1, wherein the coating further comprises one or more aluminum splats.

6. The coated overhead conductor of claim 1, wherein the coating is deposited on the surface of the conductor by a thermal spray.

7. The coated overhead conductor of claim 1 further comprising an interfacial weld between the coating and the conductor.

8. The coated overhead conductor of claim 1, wherein the coating has a thickness of about 5 μm to about 100 μm.

9. The coated overhead conductor of claim 1, wherein the coating has a thickness of about 5 μm to about 30 μm.

10. A coated overhead conductor comprising: a conductor comprising aluminum or an alloy thereof and a coating comprising a ceramic or a ceramic and a filler:
wherein the ceramic comprises alumina, mullite, spinel, black titania, cupric oxide, or a combination thereof.

11. The coated overhead conductor of claim 10, wherein the coating further comprises a hydrophobe and wherein a water droplet on the coating has a water contact angle of at least 90° and/or a slide angle of at most about 10°.

12. The coated overhead conductor of claim 10, wherein the conductor comprises an ACSS, an ACCS, a ZTACCR, or a ZTACSR.

13. The coated overhead conductor of claim 10, wherein the ceramic comprises black titania.

14. The coated overhead conductor of claim 10, wherein the filler comprises a rare earth metal compound, a graphite, a graphene, a carbon nanotube, a hexagonal boron nitride, lamp black, carbon black, cupric oxide (CuO), an iron (II) oxide, and iron (III) oxide, an iron (II,III) oxide, white titania (TiO₂), or a combination thereof.

15. The coated overhead conductor of claim 10, wherein the coating further comprises one or more aluminum splats.

16. The coated overhead conductor of claim 10, wherein the coating is deposited on the surface of the conductor by a thermal spray.

17. The coated overhead conductor of claim 10 further comprising an interfacial weld between the coating and the conductor.

18. The coated overhead conductor of claim 13 further comprising an interfacial weld between the coating and the conductor.

19. The coated overhead conductor of claim 10, wherein the coating has a thickness of about 5 μm to about 100 μm.

20. The coated overhead conductor of claim 10, wherein the coating has a thickness of about 5 μm to about 30 μm.

21. (canceled)
